(19) United States
(12) Patent Application Publication
(10) Pub. No.: US 2026/0362273 A1
(43) Pub. Date: Nov. 12, 2026

(54) EARLY TERMINATION OF ROAMING TRANSITORY PERIOD

(71) Applicant: QUALCOMM Incorporated, San Diego, CA (US)

(72) Inventors: Giovanni CHISCI, San Diego, CA (US); Sai Yiu Duncan HO, San Diego, CA (US); Abhishek Pramod PATIL, San Diego, CA (US); Gaurang NAIK, San Diego, CA (US); Alfred ASTERJADHI, San Diego, CA (US); George CHERIAN, San Diego, CA (US)

(21) Appl. No.: 19/668,624

(22) Filed: May 5, 2026

Related U.S. Application Data
(60) Provisional application No. 63/801,124, filed on May 6, 2025.

(51) Int. Cl. H04W 36/18; H04W 8/08

(52) U.S. Cl. CPC H04W 36/18; H04W 8/08

(57) ABSTRACT

Certain aspects of the present disclosure provide a method for wireless communication generally including communicating, via a first link, with a first wireless node affiliated with a single mobility domain (SMD) management entity (SMD-ME), outputting, for transmission to the first wireless node via the first link or to a second wireless node via a second link, at least a first frame to request a handover of the apparatus from the first wireless node to the second wireless node affiliated with the SMD ME, obtaining, from the first wireless node or the second wireless node, a second frame that grants the request and indicates a duration of a transitory period during which the apparatus can receive transmissions from the first wireless node before the completion of the handover, and processing, during the transitory period, a third frame that conveys information related to termination of the transitory period.

### CROSS-REFERENCE TO RELATED APPLICATIONS

This application claims priority to and benefit of U.S. Provisional Patent Application No. 63/801,124, filed May 6, 2025, which is hereby incorporated by reference herein.

### Technical Field

Aspects of the present disclosure relate to wireless communications, and more particularly, to techniques for wireless local area network (WLAN) roaming.

### Description of the Related Technology

A wireless local area network (WLAN) may be formed by one or more wireless access points (APs) that provide a shared wireless communication medium for use by multiple client devices also referred to as wireless stations (STAs). The basic building block of a WLAN conforming to the Institute of Electrical and Electronics Engineers (IEEE) 802.11 family of standards is a Basic Service Set (BSS), which is managed by an AP. Each BSS is identified by a Basic Service Set Identifier (BSSID) that is advertised by the AP. An AP periodically broadcasts beacon frames to enable any STAs within wireless range of the AP to establish or maintain a communication link with the WLAN.

### SUMMARY

One aspect provides a method for wireless communication that generally includes communicating with a first wireless node affiliated with a single mobility domain (SMD) management entity (SMD-ME), transmitting, to the first wireless node via the first link or to a second wireless node via a second link, at least a first frame to request a handover of the apparatus from the first wireless node to the second wireless node affiliated with the SMD ME, receiving, via the at least one transceiver from the first wireless node or the second wireless node, a second frame that grants the request and indicates a duration of a transitory period during which the apparatus can receive transmissions from the first wireless node before completion of the handover; and processing, during the transitory period, a third frame that conveys information related to termination of the transitory period.

Another aspect provides a method for wireless communication that generally includes communicating, via the at least one transceiver and a first link, with a first wireless node, receiving, from the first wireless node via the at least one transceiver and the first link, at least a first frame to request a handover of the first wireless node from the apparatus to a second wireless node, wherein the apparatus and the second wireless node are affiliated with a single mobility domain (SMD) management entity (SMD ME), transmitting, to the first wireless node via the at least one transceiver, a second frame that grants the request and indicates a duration of a transitory period during which the apparatus can receive transmissions from the first wireless node before completion of the handover, and processing, during the transitory period, a third frame that conveys information related to termination of the transitory period.

Another aspect provides a method for wireless communication that generally includes communicating, via the at least one transceiver, with a first wireless node during a handover of the first wireless node from a second wireless node to the apparatus, wherein the apparatus and the second wireless node are affiliated with a single mobility domain (SMD) management entity (SMD ME) and processing, during a transitory period during which the first wireless node can receive transmissions from the apparatus and the second wireless node before completion of the handover, a frame that conveys information related to termination of the transitory period.

Other aspects provide: an apparatus operable, configured, or otherwise adapted to perform any one or more of the aforementioned methods and/or those described elsewhere herein; a non-transitory, computer-readable media comprising instructions that, when executed by a processor of an apparatus, cause the apparatus to perform the aforementioned methods as well as those described elsewhere herein; a computer program product embodied on a computer-readable storage medium comprising code for performing the aforementioned methods as well as those described elsewhere herein; and/or an apparatus comprising means for performing the aforementioned methods as well as those described elsewhere herein. By way of example, an apparatus may comprise a processing system, a device with a processing system, or processing systems cooperating over one or more networks.

The following description and the appended figures set forth certain features for purposes of illustration. Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF DRAWINGS

The appended figures depict certain features of the various aspects described herein and are not to be considered limiting of the scope of this disclosure.

FIG. 1 shows a pictorial diagram of an example wireless communication network.

FIG. 2 shows a hierarchical format of an example physical layer PDU (PPDU) usable for communications between a wireless AP and one or more wireless STAs.

FIG. 3 depicts a block diagram of an example multi-link device (MLD) deployment.

FIG. 4 depicts an example multi-link operation (MLO) architecture.

FIGS. 5A, 5B and 5C depict an example make-before-break handover implemented in an MLO architecture.

FIGS. 6A, 6B and 6C depict an example associated link set and an example enable link set before, during, and after a make-before-break handover.

FIG. 7 depicts an example transfer of multi-link device (MLD) context including a handover buffer during a make-before-break handover.

FIG. 8 depicts an example call flow for a network initiated make-before break handover.

FIG. 9 depicts an example call flow for a client initiated make-before break handover.

FIG. 10 depicts an example call flow for a station initiated handover, in accordance with certain aspects of the present disclosure.

FIGS. 11, 12, 13A, 13B, 14, 15, 16, 17A, 17B, and 18 depict example frame, field, and subfield formats, in accordance with certain aspects of the present disclosure.

FIG. 19 depicts an example call flow for a station initiated handover, in accordance with certain aspects of the present disclosure.

FIGS. 20, 21, 22A, 22B and 23 depict example frame, field, and subfield formats, in accordance with certain aspects of the present disclosure.

FIG. 24 shows a flowchart illustrating an example process performable by or at a wireless node (e.g., a non-AP MLD STA) that supports early termination.

FIG. 25 shows a flowchart illustrating an example process performable by or at a wireless node (e.g., a current AP MLD) that supports early termination.

FIG. 26 shows a flowchart illustrating an example process performable by or at a wireless node (e.g., a target AP MLD) that supports early termination.

FIGS. 27 depicts a block diagram of an example wireless communications device.

### DETAILED DESCRIPTION

Aspects of the present disclosure provide apparatuses, methods, processing systems, and computer-readable mediums for wireless local area network (WLAN) roaming.

In conventional wireless communication systems, when a station (STA) roams between multiple access points (APs), the STA needs to re-associate with a new (target) AP and perform an association procedure (e.g., including a 4-way handshake procedure). The 4-way handshake procedure is the process of exchanging of four messages between an AP and a non-AP MLD to generate and exchange various encryption keys used encrypt data sent between the AP and STA. This four-message exchange may cause undue delay when a STA roams between APs, but needs to be performed before the network can switch the data path. Thus, this type of roaming or handover between APs is referred to as a break-before-make handover, because the connection to the serving AP is broken before the connection to the target AP is made, which creates data interruption and extra delay during the handover procedure.

Aspects of the present disclosure provide various techniques to address this issue, taking advantage of features of a multi-link operation (MLO) architecture. MLO generally refers to a feature in advanced wireless systems (e.g., such as that defined by the IEEE 802.11-2020 specification or amendments thereof including, but not limited to 802.11be Extremely High Throughput (EHT) and the 802.11 amendment associated with Wi-Fi 8)) that enables the utilization of multiple links using individual frequency channels to transmit and receive between devices. MLO may enable concurrent utilization of multiple radio links of different frequency channels/bands by an AP, a client, or both. A device capable of MLO is generally referred to as a multi-link device (MLD).

Allowing a STA to roam between the AP devices affiliated with a same single mobility domain (SMD) entity, without requiring reassociation, may be referred to herein as seamless roaming. In the present disclosure, seamless roaming may also be referred to simply as roaming or as SMD basic service set (BSS) transition.

In the context of seamless roaming, when a non-AP MLD (‘STA’) initiates roaming (via an execution request/execution response handshake) from the current AP MLD (referred to as AP1) to the target AP MLD (referred to as AP2), the STA may be provided with a timeout (duration) of a transitory period.

The transitory period generally refers to a temporary phase when the STA is transitioning from AP1 to AP2 while trying to maintain continuous service and avoid disruption of current sessions (e.g., for voice or video). During the transitory period, the STA may maintain an existing connection to AP1. The transitory period may generally be defined as the interval between the start of the reassociation process and the completion of the new association. During this transitory period, the STA may use MLO to simultaneously maintain links to both the current and target APs. The transitory period may be designed to help achieve minimal packet loss, a low-latency handover, and session continuity.

Aspects of the present disclosure provide various signaling mechanisms that may help enhance transitory periods. For example, the signaling mechanisms may help support early termination of the transitory period.

The signaling mechanisms proposed herein may include an AP1 to STA indication that the current AP (AP1) has no more downlink data (e.g., for one or more traffic identifiers (TIDs) or across all TIDs, and no further downlink data is buffered or expected), which may be beneficial by aiding the STA in deciding to terminate the transitory period early and complete the move to AP2. The signaling mechanisms proposed herein may also support STA to AP2 indication of ‘early termination’ which may be beneficial by helping to release the target AP (AP2) from constraints that AP2 is subject to during the transitory period. The signaling mechanisms proposed herein may also support STA to AP1 indication of ‘early termination’ which may be beneficial by releasing AP1 from unnecessarily transmitting DL data.

### Example Wireless Communication Network

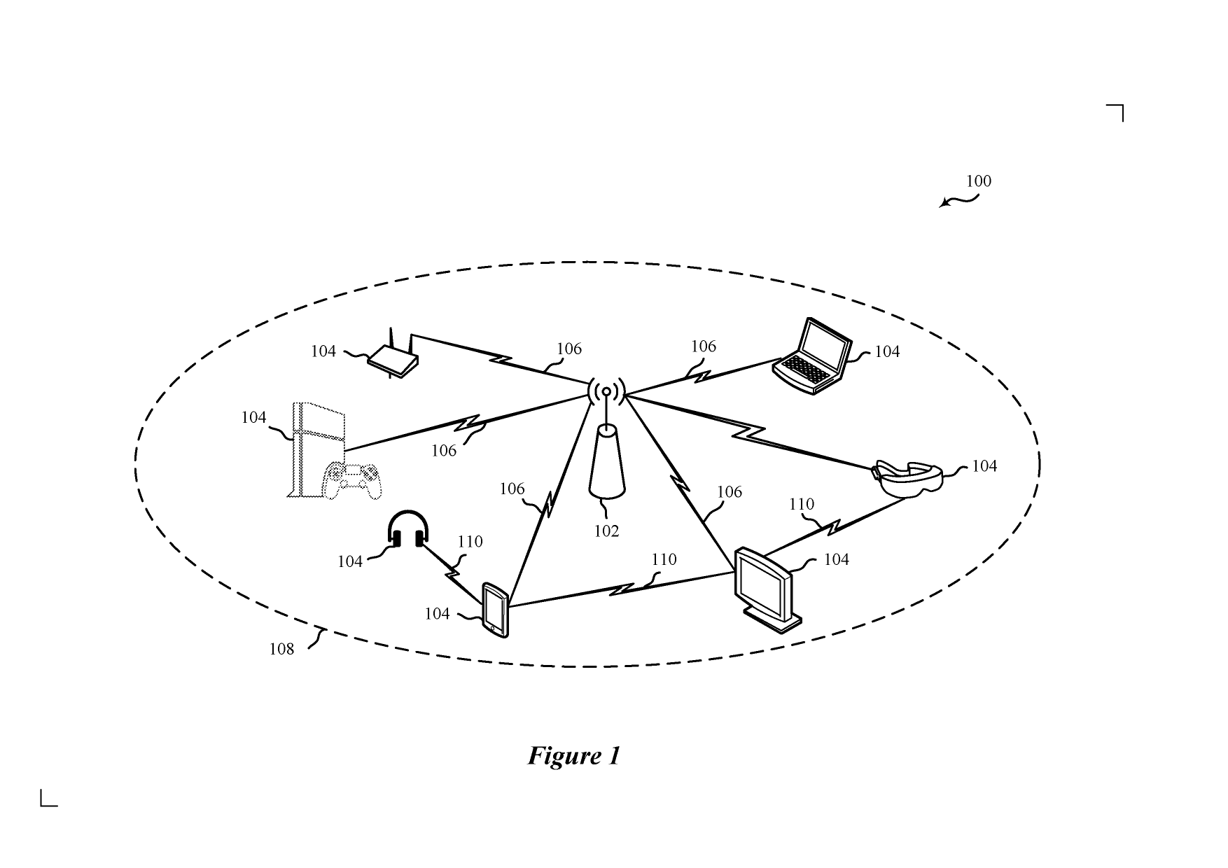

FIG. 1 shows a pictorial diagram of an example wireless communication network 100. The wireless communication network 100 includes various wireless nodes (such as AP STAs and non-AP STAs). According to some aspects, the wireless communication network 100 can be an example of a wireless local area network (WLAN) such as a Wi-Fi network. For example, the wireless communication network 100 can be a network implementing at least one of the IEEE 802.11 family of wireless communication protocol standards (such as defined by the IEEE 802.11-2020 specification or amendments thereof including, but not limited to, 802.11ay, 802.11ax, 802.11az, 802.11ba, 802.11bd, 802.11be, 802.11bf, and 802.11bn). In some other examples, the wireless communication network 100 can be an example of a cellular radio access network (RAN), such as a 5G or 6G RAN that implements one or more cellular protocols such as those specified in one or more 3GPP standards. In some other examples, the wireless communication network 100 can include a WLAN that functions in an interoperable or converged manner with one or more cellular RANs to provide greater or enhanced network coverage to wireless communication devices within the wireless communication network 100 or to enable such devices to connect to a cellular network’s core, such as to access the network management capabilities and functionality offered by the cellular network core.

The wireless communication network 100 may include numerous wireless communication devices including at least one wireless access point (AP) 102 and any number of wireless stations (STAs) 104. While only one AP 102 is shown in FIG. 1, the wireless communication network 100 can include multiple APs 102. The AP 102 can be or represent various different types of network entities including, but not limited to, a home networking AP, an enterprise-level AP, a single-frequency AP, a dual-band simultaneous (DBS) AP, a tri-band simultaneous (TBS) AP, a standalone AP, a non-standalone AP, a software-enabled AP (soft AP), and a multi-link AP (also referred to as an AP multi-link device (MLD)), as well as cellular (such as 3GPP, 4G LTE, 5G or 6G) base stations or other cellular network nodes such as a Node B, an evolved Node B (eNB), a gNB, a transmission reception point (TRP) or another type of device or equipment included in a radio access network (RAN), including Open-RAN (O-RAN) network entities, such as a central unit (CU), a distributed unit (DU) or a radio unit (RU).

Each of the STAs 104 also may be referred to as a mobile station (MS), a mobile device, a mobile handset, a wireless handset, an access terminal (AT), a user equipment (UE), a subscriber station (SS), or a subscriber unit, among other examples. The STAs 104 may represent various devices such as mobile phones, other handheld or wearable communication devices, netbooks, notebook computers, tablet computers, laptops, Chromebooks, augmented reality (AR), virtual reality (VR), mixed reality (MR) or extended reality (XR) wireless headsets or other peripheral devices, wireless earbuds, other wearable devices, display devices (for example, TVs, computer monitors or video gaming consoles), video game controllers, navigation systems, music or other audio or stereo devices, remote control devices, printers, kitchen appliances (including smart refrigerators) or other household appliances, key fobs (for example, for passive keyless entry and start (PKES) systems), Internet of Things (IoT) devices, and vehicles, among other examples.

A single AP 102 and an associated set of STAs 104 may be referred to as a basic service set (BSS), which is managed by the respective AP 102. FIG. 1 additionally shows an example coverage area 108 of the AP 102, which may represent a basic service area (BSA) of the wireless communication network 100. The BSS may be identified by STAs 104 and other devices by a service set identifier (SSID), as well as a basic service set identifier (BSSID), which may be a medium access control (MAC) address of the AP 102. The AP 102 may periodically broadcast beacon frames (“beacons”) including the BSSID to enable any STAs 104 within wireless range of the AP 102 to “associate” or re-associate with the AP 102 to establish a respective communication link 106 (hereinafter also referred to as a “Wi-Fi link”), or to maintain a communication link 106, with the AP 102. For example, the beacons can include an identification or indication of a primary channel used by the respective AP 102 as well as a timing synchronization function (TSF) for establishing or maintaining timing synchronization with the AP 102. The AP 102 may provide access to external networks to various STAs 104 in the wireless communication network 100 via respective communication links 106.

To establish a communication link 106 with an AP 102, each of the STAs 104 is configured to perform passive or active scanning operations (“scans”) on frequency channels in one or more frequency bands (for example, the 2.4 GHz, 5 GHz, 6 GHz, 45 GHz, or 60 GHz bands). To perform passive scanning, a STA 104 listens for beacons, which are transmitted by respective APs 102 at periodic time intervals referred to as target beacon transmission times (TBTTs). To perform active scanning, a STA 104 generates and sequentially transmits probe requests on each channel to be scanned and listens for probe responses from APs 102. Each STA 104 may identify, determine, ascertain, or select an AP 102 with which to associate in accordance with the scanning information obtained through the passive or active scans, and to perform authentication and association operations to establish a communication link 106 with the selected AP 102. The selected AP 102 assigns an association identifier (AID) to the STA 104 at the culmination of the association operations, which the AP 102 uses to track the STA 104.

As a result of the increasing ubiquity of wireless networks, a STA 104 may have the opportunity to select one of many BSSs within range of the STA 104 or to select among multiple APs 102 that together form an extended service set (ESS) including multiple connected BSSs. For example, the wireless communication network 100 may be connected to a wired or wireless distribution system that may enable multiple APs 102 to be connected in such an ESS. As such, a STA 104 can be covered by more than one AP 102 and can associate with different APs 102 at different times for different transmissions. Additionally, after association with an AP 102, a STA 104 also may periodically scan its surroundings to find a more suitable AP 102 with which to associate. For example, a STA 104 that is moving relative to its associated AP 102 may perform a “roaming” scan to find another AP 102 having more desirable network characteristics such as a greater received signal strength indicator (RSSI) or a reduced traffic load.

In some cases, STAs 104 may form networks without APs 102 or other equipment other than the STAs 104 themselves. One example of such a network is an ad hoc network (or wireless ad hoc network). Ad hoc networks may alternatively be referred to as mesh networks or peer-to-peer (P2P) networks. In some cases, ad hoc networks may be implemented within a larger network such as the wireless communication network 100. In such examples, while the STAs 104 may be capable of communicating with each other through the AP 102 using communication links 106, STAs 104 also can communicate directly with each other via direct wireless communication links 110. Additionally, two STAs 104 may communicate via a direct communication link 110 regardless of whether both STAs 104 are associated with and served by the same AP 102. In such an ad hoc system, one or more of the STAs 104 may assume the role filled by the AP 102 in a BSS. Such a STA 104 may be referred to as a group owner (GO) and may coordinate transmissions within the ad hoc network. Examples of direct wireless communication links 110 include Wi-Fi Direct connections, connections established by using a Wi-Fi Tunneled Direct Link Setup (TDLS) link, and other P2P group connections.

In some networks, the AP 102 or the STAs 104, or both, may support applications associated with high throughput or low-latency requirements, or may provide lossless audio to one or more other devices. For example, the AP 102 or the STAs 104 may support applications and use cases associated with ultra-low-latency (ULL), such as ULL gaming, or streaming lossless audio and video to one or more personal audio devices (such as peripheral devices) or AR/VR/MR/XR headset devices. In scenarios in which a user uses two or more peripheral devices, the AP 102 or the STAs 104 may support an extended personal audio network enabling communication with the two or more peripheral devices. Additionally, the AP 102 and STAs 104 may support additional ULL applications such as cloud-based applications (such as VR cloud gaming) that have ULL and high throughput requirements.

As indicated above, in some implementations, the AP 102 and the STAs 104 may function and communicate (via the respective communication links 106) according to one or more of the IEEE 802.11 family of wireless communication protocol standards. These standards define the WLAN radio and baseband protocols for the physical (PHY) and MAC layers. The AP 102 and STAs 104 transmit and receive wireless communications (hereinafter also referred to as “Wi-Fi communications” or “wireless packets”) to and from one another in the form of PHY protocol data units (PPDUs).

Each PPDU is a composite structure that includes a PHY preamble and a payload that is in the form of a PHY service data unit (PSDU). The information provided in the preamble may be used by a receiving device to decode the subsequent data in the PSDU. In instances in which a PPDU is transmitted over a bonded or wideband channel, the preamble fields may be duplicated and transmitted in each of multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is associated with the particular IEEE 802.11 wireless communication protocol to be used to transmit the payload.

The APs 102 and STAs 104 in the WLAN 100 may transmit PPDUs over an unlicensed spectrum, which may be a portion of spectrum that includes frequency bands traditionally used by Wi-Fi technology, such as the 2.4 GHz, 5 GHz, 6 GHz, 45 GHz, and 60 GHz bands. Some examples of the APs 102 and STAs 104 described herein also may communicate in other frequency bands that may support licensed or unlicensed communications. For example, the APs 102 or STAs 104, or both, also may be capable of communicating over licensed operating bands, where multiple operators may have respective licenses to operate in the same or overlapping frequency ranges. Such licensed operating bands may map to or be associated with frequency range designations of FR1 (410 MHz – 7.125 GHz), FR2 (24.25 GHz – 52.6 GHz), FR3 (7.125 GHz – 24.25 GHz), FR4a or FR4-1 (52.6 GHz – 71 GHz), FR4 (52.6 GHz – 114.25 GHz), and FR5 (114.25 GHz – 300 GHz).

Each of the frequency bands may include multiple sub-bands and frequency channels (also referred to as subchannels). For example, PPDUs conforming to the IEEE 802.11n, 802.11ac, 802.11ax, 802.11be and 802.11bn standard amendments may be transmitted over one or more of the 2.4 GHz, 5 GHz, or 6 GHz bands, each of which is divided into multiple 20 MHz channels. As such, these PPDUs are transmitted over a physical channel having a minimum bandwidth of 20 MHz, but larger channels can be formed through channel bonding. For example, PPDUs may be transmitted over physical channels having bandwidths of 40 MHz, 80 MHz, 160 MHz, 240 MHz, 320 MHz, 480 MHz, or 640 MHz by bonding together multiple 20 MHz channels.

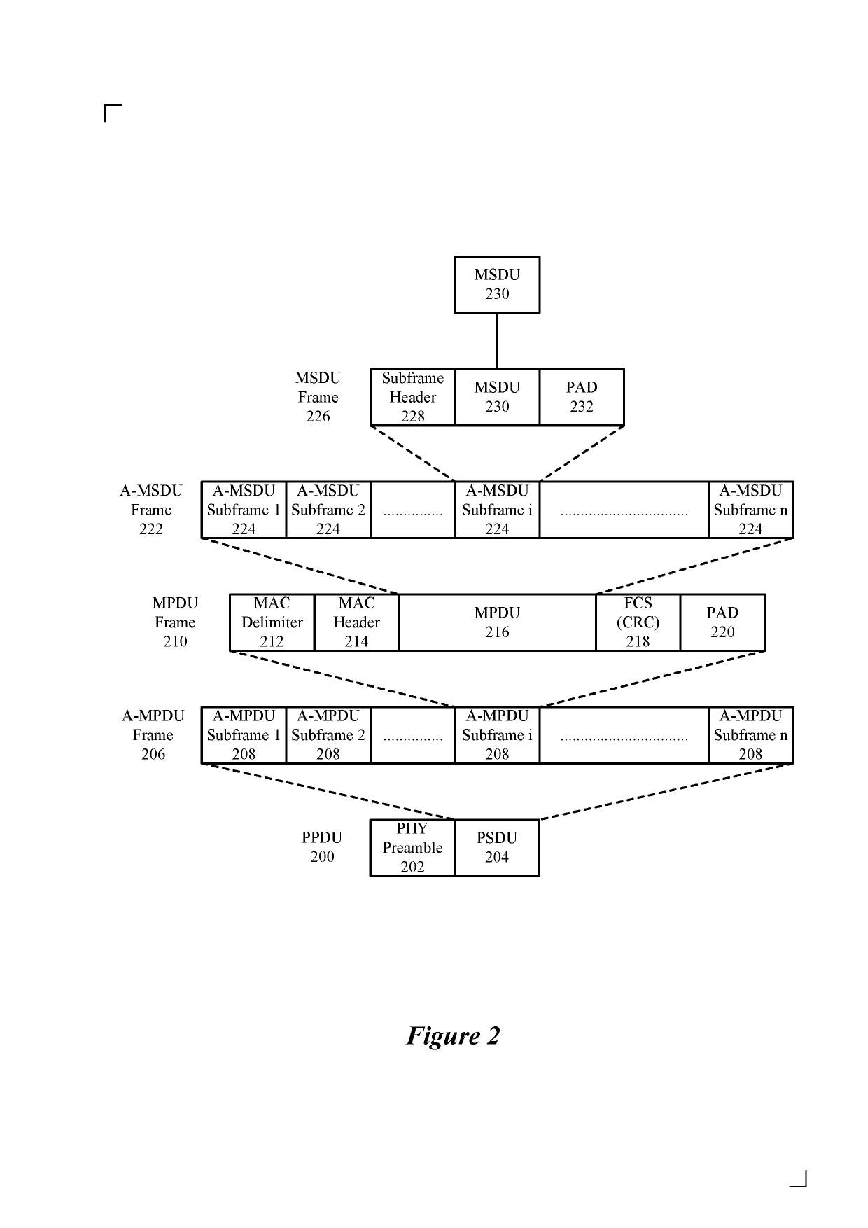

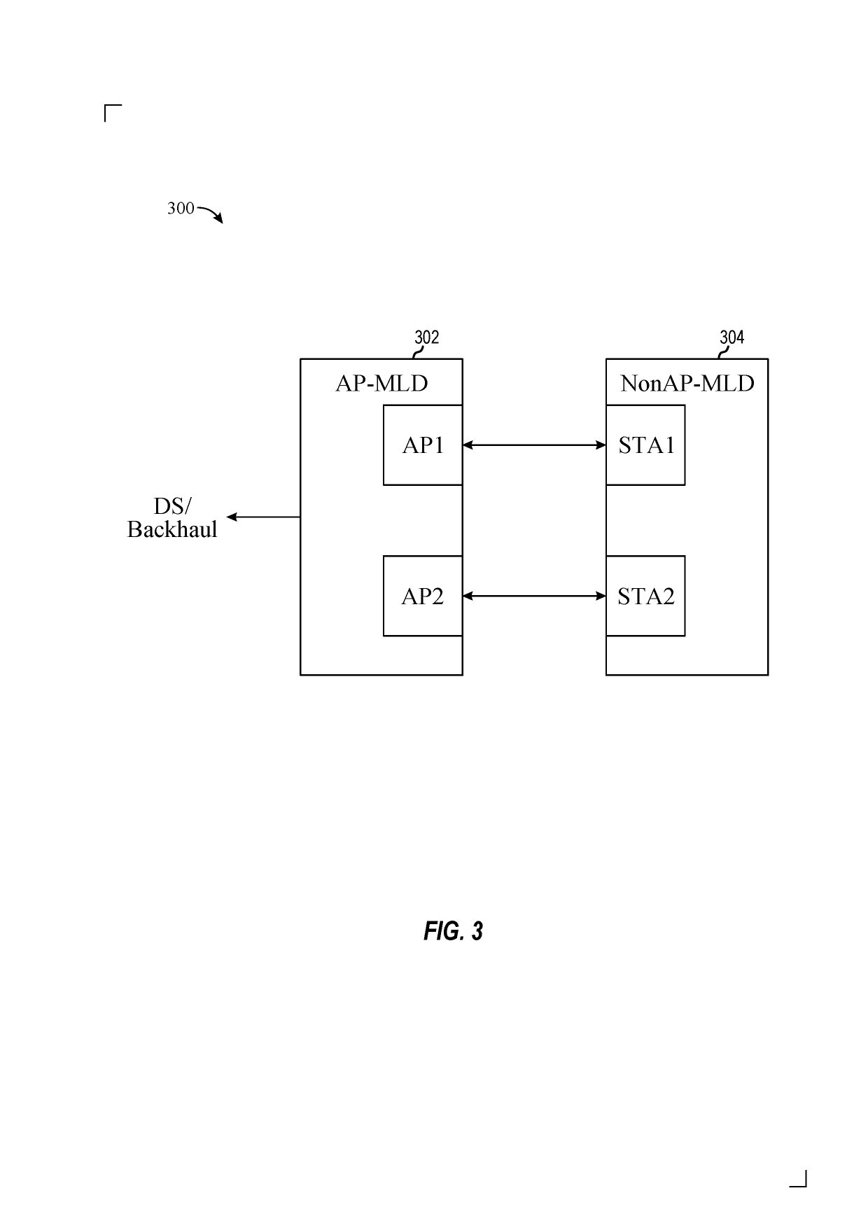

FIG. 2 shows a hierarchical format of an example PPDU usable for communications between a wireless AP 102 and one or more wireless STAs 104. As described, each PPDU 400 includes a PHY preamble 402 and a PSDU 404. Each PSDU 404 may represent (or “carry”) one or more MAC protocol data units (MPDUs) 416. For example, each PSDU 404 may carry an aggregated MPDU (A-MPDU) 406 that includes an aggregation of multiple A-MPDU subframes 408. Each A-MPDU subframe 408 may include an MPDU frame 410 that includes a MAC delimiter 412 and a MAC header 414 prior to the accompanying MPDU 416, which includes the data portion (“payload” or “frame body”) of the MPDU frame 410. Each MPDU frame 410 also may include a frame check sequence (FCS) field 418 for error detection (for example, the FCS field may include a cyclic redundancy check (CRC)) and padding bits 420. The MPDU 416 may carry one or more MAC service data units (MSDUs) 422. For example, the MPDU 416 may carry an aggregated MSDU (A-MSDU) 422 including multiple A-MSDU subframes 424. Each A-MSDU subframe 424 contains a corresponding MSDU 430 preceded by a subframe header 428 and in some cases followed by padding bits 432.

Referring back to the MPDU frame 410, the MAC delimiter 412 may serve as a marker of the start of the associated MPDU 416 and indicate the length of the associated MPDU 416. The MAC header 414 may include multiple fields containing information that defines or indicates characteristics or attributes of data encapsulated within the frame body 416. The MAC header 414 includes a duration field indicating a duration extending from the end of the PPDU until at least the end of an acknowledgment (ACK) or Block ACK (BA) of the PPDU that is to be transmitted by the receiving wireless communication device. The use of the duration field serves to reserve the wireless medium for the indicated duration, and enables the receiving device to establish its network allocation vector (NAV). The MAC header 414 also includes one or more fields indicating addresses for the data encapsulated within the frame body 416. For example, the MAC header 414 may include a combination of a source address, a transmitter address, a receiver address or a destination address. The MAC header 414 may further include a frame control field containing control information. The frame control field may specify a frame type, for example, a data frame, a control frame, or a management frame.

### Overview of Multi-Link Devices

A multi-link device (MLD) generally refers to a single device or equipment that includes two or more station (STA) instances or entities, implemented in a physical (PHY)/medium access control (MAC) layer and configured to communicate on separate wireless links. In some examples, each MLD may include a single higher layer entity, such as a MAC Service Access Point (SAP) that may assign MAC protocol data units (MPDUs) for transmission by the separate STA instances.

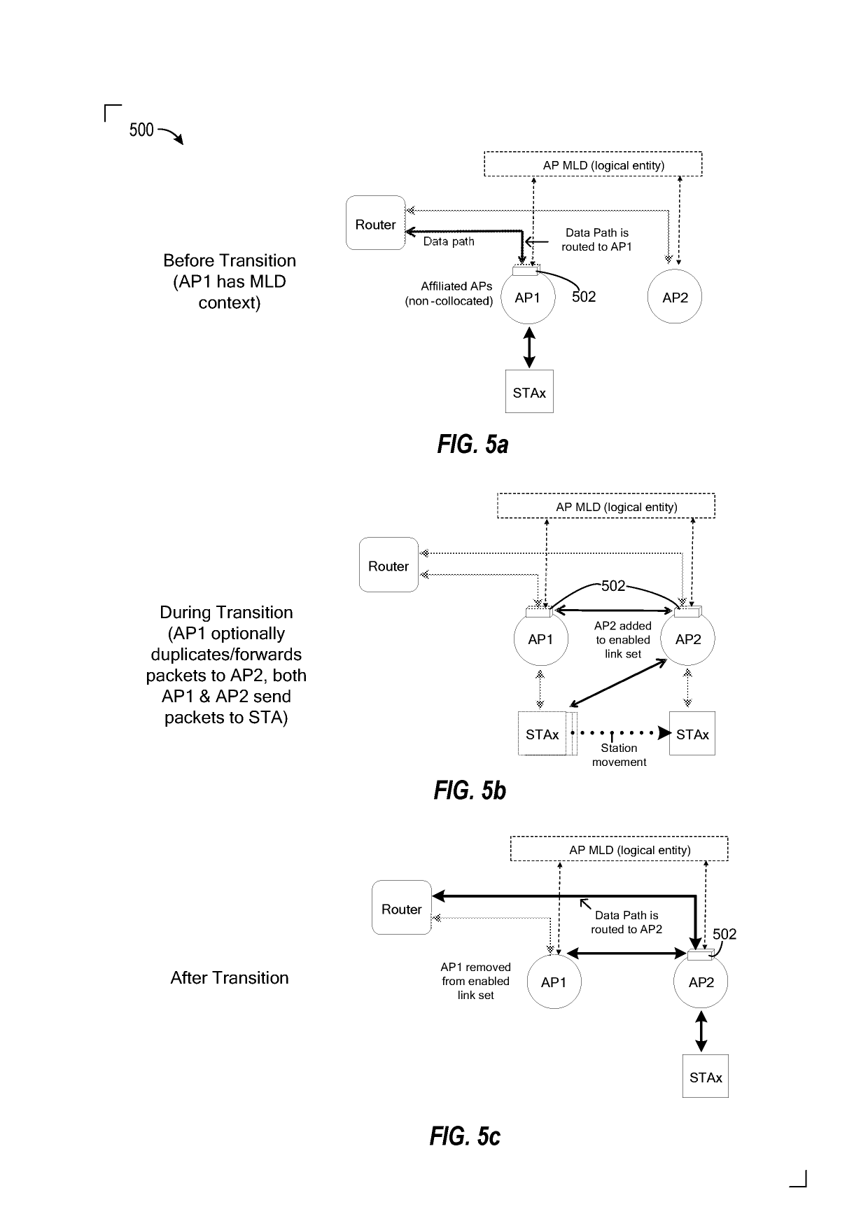

FIG. 5 depicts a block diagram of an example multi-link device (MLD) deployment.

As shown in FIG. 5, an access point (AP) MLD 502 may communicate with a non-AP MLD 504. Each of the AP MLD and non-AP MLD may include at least two STA entities 514 (hereinafter also referred to simply as “STAs”) that may communicate with associated STAs of another MLD. In an AP MLD, the STAs may be AP STAs 512 (STAs serving as APs or simply “APs”). In a non-AP MLD, the STAs may be non-AP STAs (STAs not serving as APs). As also described above, MLDs may utilize multi-link aggregation (MLA) (which includes packet level aggregation), whereby MPDUs from a same traffic ID (TID) may be sent via two or more wireless links.

Various modes of communication may be employed in MLD implementations. For example, a MLD may communicate in an Asynchronous (Async) mode or a Synchronous (Sync) mode. The Async mode provides flexibility to adapt to channel loading, allowing an MLD to perform channel access, transmit, and receive data via multiple links asynchronously. Sync mode may be preferred, however, if RF leakage exists between channels, because synchronized transmission on all links is unaffected by RF leakage.

In the Async mode, a STA/AP may count down (e.g., via a random backoff (RBO)) on both wireless links. A physical layer convergence protocol (PLCP) protocol data units (PPDU) start/end may happen independently on each of the wireless links. As a result, Async mode may potentially provide latency and aggregation gains. In certain cases, relatively complex (and costly) filters may be needed (for example, in the case of 5GHz+6GHz aggregation).

In the Sync mode, a STA/AP may also perform a backoff countdown on multiple wireless links as part of a channel access procedure. If a first link gains access to the medium through the channel access procedure, multiple links may transmit PPDUs at the same time. Accordingly, this mode may need some restrictions to minimize in-device interference.

The Sync mode may work in 5GHz+6GHz aggregation and may require relatively low-filter performance, while still providing latency and aggregation gains. However, due to that STA’s tiled architecture, this latency and aggregation gains may be hard to achieve.

Although not shown, a third mode of communication may include a Basic (for example, multi-primary with single link transmission) mode. In the Basic mode, a STA/AP may also count down on both wireless links. However, transmission may only occur on the wireless link that gains access to the medium. The other wireless link may be blocked by in-device interference greater than -62 decibels per milliwatt (dBm). No aggregation gains may be realized in this mode.

In some cases, APs (e.g., non-collocated APs present at different physical locations) may be connected as affiliated APs of a single AP MLD. As a result, when a STA (e.g., of a non-AP MLD) transitions between these APs, the STA can bypass MLO (re)association and the 4-way handshake procedure. These techniques may be referred to as seamless roaming or make-before-break handover procedures, which may avoid data interruption and reduce delay during handover.

Seamless roaming may be considered a useful feature in ultra-high reliability (UHR) networks, enabling a client device to move from one serving AP to another without requiring reassociation. Seamless roaming may involve a UHR AP providing information related to a single mobility domain (SMD) entity (e.g., an SMD AP MLD), advertising candidate AP(s) for a client to select for roaming and possibly a transfer of context between APs. Such a handover may be initiated by a non-AP MLD (e.g., a STA), or the network may recommend to a non-AP MLD to move to a different set of (e.g., collocated or noncollocated) serving APs.

### Overview of Roaming

As noted above, conventional wireless communication systems typically only support a break-before-make handover procedure, requiring a STA to perform an association procedure when roaming between multiple APs. This approach creates data interruption and extra delay during the handover procedure.

Aspects of the present disclosure, however, support a make-before-break handover procedure, which may avoid data interruption and reduce delay during handover.

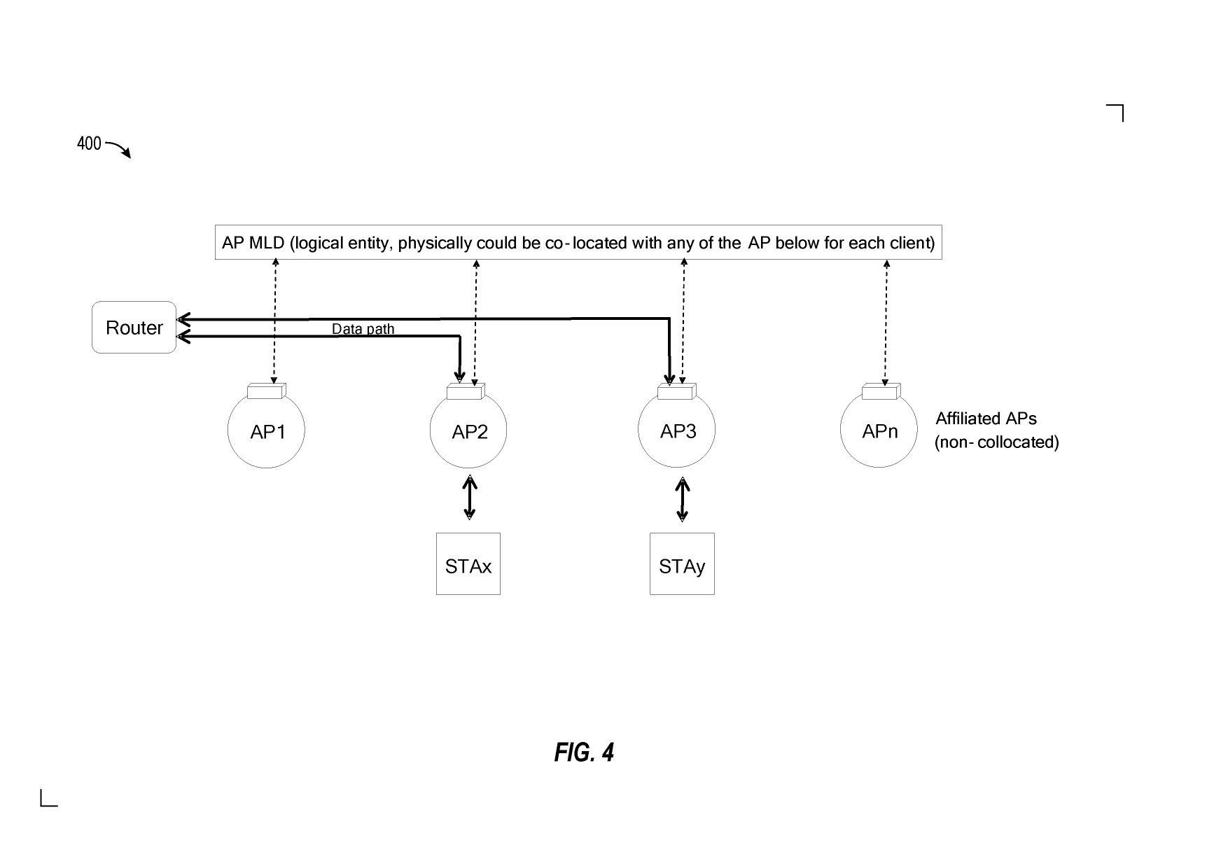

Aspects of the present disclosure may be implemented, for example, in the architecture multi-link operation (MLO) architecture illustrated in FIG. 4. The MLO architecture of FIG. 4 may allow non-collocated APs to be affiliated with a single AP MLD 402. In this manner, an AP MLD may be considered a logical entity which is collocated physically with any of a set of non-collocated APs 412 affiliated with the AP MLD.

FIGS. 5A-5C illustrate example operations before, during, and after a make-before-break handover, in accordance with aspects of the present disclosure.

As illustrated in FIG. 5A, before the handover, a STA (e.g., STAx) within the MLO architecture has an active link with only a serving AP (AP1). At this point, the link with AP1 is in the only link in an enabled-link set and the data path is routed to AP1. AP1 hosts MLD context 502 for the client (e.g., STAx). While AP1 and the target AP (AP2) are collocated and may be affiliated within an associated link set, AP2 is not in the enabled-link set at this point.

As illustrated in FIG. 5B, however, as STAx moves towards AP2, the link to AP2 may be enabled during the make-before-break handover. This transition may occur where, as illustrated, the STAx moves closer to AP2. At this point, AP2 is added to the enabled link set alongside AP1 and both AP1 and AP2 exchange packets to client (as the link with AP2 was made before the link with AP1 was broken). Optionally, AP1 duplicates/forwards packets to AP2 as part of the transition.

As illustrated in FIG. 5C, after the transition, AP1 is removed from the enabled link set and the data path re-routed to AP2. At this point, AP2 hosts the MLD context for the client.

By implementing the multi-AP association described herein, data disruptions (e.g., MSDUs loss, duplicated MSDUs, or out-of-order MSDUs delivery) during handover may be mitigated. Thus, issues of delay and disruption present in typical MLO re-association or 4-way handshake procedures are avoided. Instead, there is minimal interruption and delay on the data path during handover. The multi-AP association also does not require association/association, or the related security steps. Implementation of the multi-AP association may allow mobility among a large number of APs (e.g., a single floor covered with 50 APs in an enterprise network).

According to aspects of the present disclosure, the make-before-break handover may be implemented within a multi-link architecture according to certain extensions

In one example, certain mechanisms may be allowed for the client (e.g., a STA) to associate with a subset of the APs (associated link set), and then add/remove APs to the associated link set. In this case, it is not scalable for a non-AP MLD (e.g., a STA) to request and set up all the links at the same time. When a STA is deployed, only some of the APs are within range of the STA, so not all the links can be used concurrently, thus simultaneous set-up may not be necessary. Accordingly, an associated link set that is defined for a given STA may allow for better multi-AP association within the multi-link architecture.

In another example, certain mechanisms may be enabled for distribution system (DS) /Backhaul to connect directly to the AP(s) serving the client (STA). This may imply that the backhaul/DS point of attachment moves when the client moves from an AP to another AP.

As noted above, multiple non-collocated APs within a network topology may be affiliated with a single AP MLD. There may be a large number of APs. For example, all APs in one company floor may belong to the same AP MLD. The non-AP MLD (e.g., STA) performs handover as it moves across the company floor.

According to certain aspects, MLO association and authentication may be implemented to enable a non-AP MLD to associate with the AP MLD. For example, 11be ML discovery may be extended and ML authentication and association, Pairwise Transient Key Security Association (PTKSA), block acknowledgment (BA), and the like, may be reused. In certain cases, an affiliated AP may advertise its neighboring APs in its beacon (and these neighboring APs may be identified as potential handover targets by a STA).

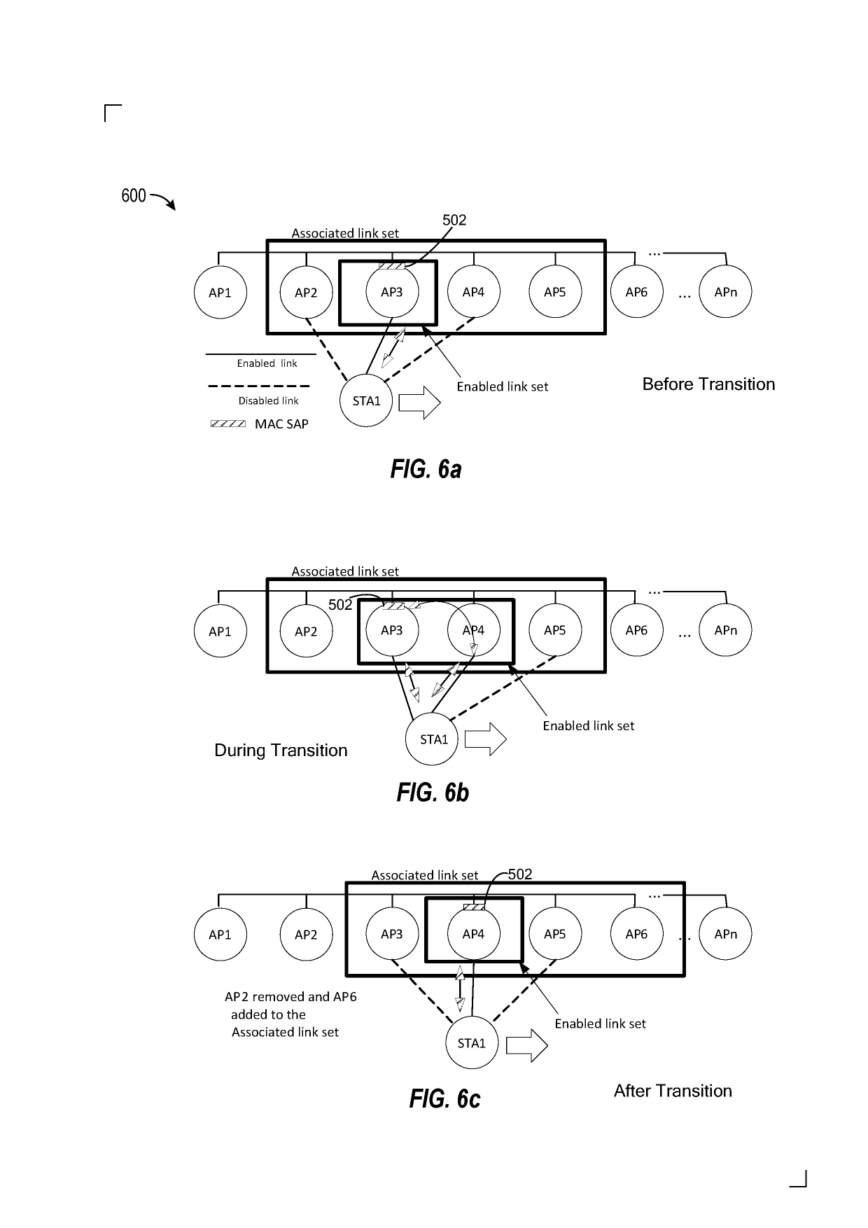

As illustrated in FIGS. 6A-6C, according to certain aspects, an associated link set may be maintained. An associated link set is a subset of the affiliated that are currently “associated” with the non-AP MLD. To maintain the associated link set, an affiliated AP may be added to the associated link set once it’s in range (with threshold/time hysteresis). AN affiliated AP may be removed from the set once it’s out-of-range (with threshold/time hysteresis). For example, existing 11be ML link reconfiguration may be used to add/remove link(s) dynamically without (re-)association. The enabled link set described herein is a subset of the associated link set.

FIGS. 6A-6C illustrate an example associated link set and an example enable link set before, during, and after a make-before break handover. In the example, STA1 (a non-AP MLD) moves to the right.

FIG. 6A illustrates an example associated link set and an example enable link set before the make-before-break handover. Here, AP2-AP5 are part of the associated link set. In this example, AP3 is currently serving the STA, so that (the link to) AP3 is the only member of the enabled link set and hosts the MDL context 502.

As illustrated in FIG. 6B, as the STA moves, a link to AP4 is enabled, without breaking the link to AP3. Here, the redundant link may be used for duplicated data exchange during handover.

As illustrated in FIG. 6C, after the handover, MLD context 502 is relocated from AP3 to AP4. In this example, AP3 is removed from the enabled link set, AP2 is removed from the associated link set, and AP6 added to the associated link set.

According to certain aspects, pre-handover preparation may occur on the network side. In some cases, an AP MLD may detect the presence of handover conditions. In other cases, handover can be triggered by the non-AP MLD itself (e.g., use auxiliary radio to look for target APs). Once handover is decided, network can initiate the handover transition stage. During the handover transition stage, duplicated packets may be sent on multiple links for reliability and reduced delay. Existing 11be MLD procedures and signaling may be used to remove any duplicated packets. The MLD context (e.g., association, authentication, BA) may be relocated to the new (anchor) AP and duplicated transmission may be terminated.

Implementation of techniques described herein may reuse certain existing 11be mechanisms. For example, ML setup (e.g., association and authentication, PTKSA, BA, and the like) and ML reconfiguration (to add/remove link(s)) for the enabled link set may be reused. Additionally, an AP beacon may include neighboring APs. The associated link set may be maintained. The medium access control (MAC) serving AP (SAP) and MLD context may be maintained.

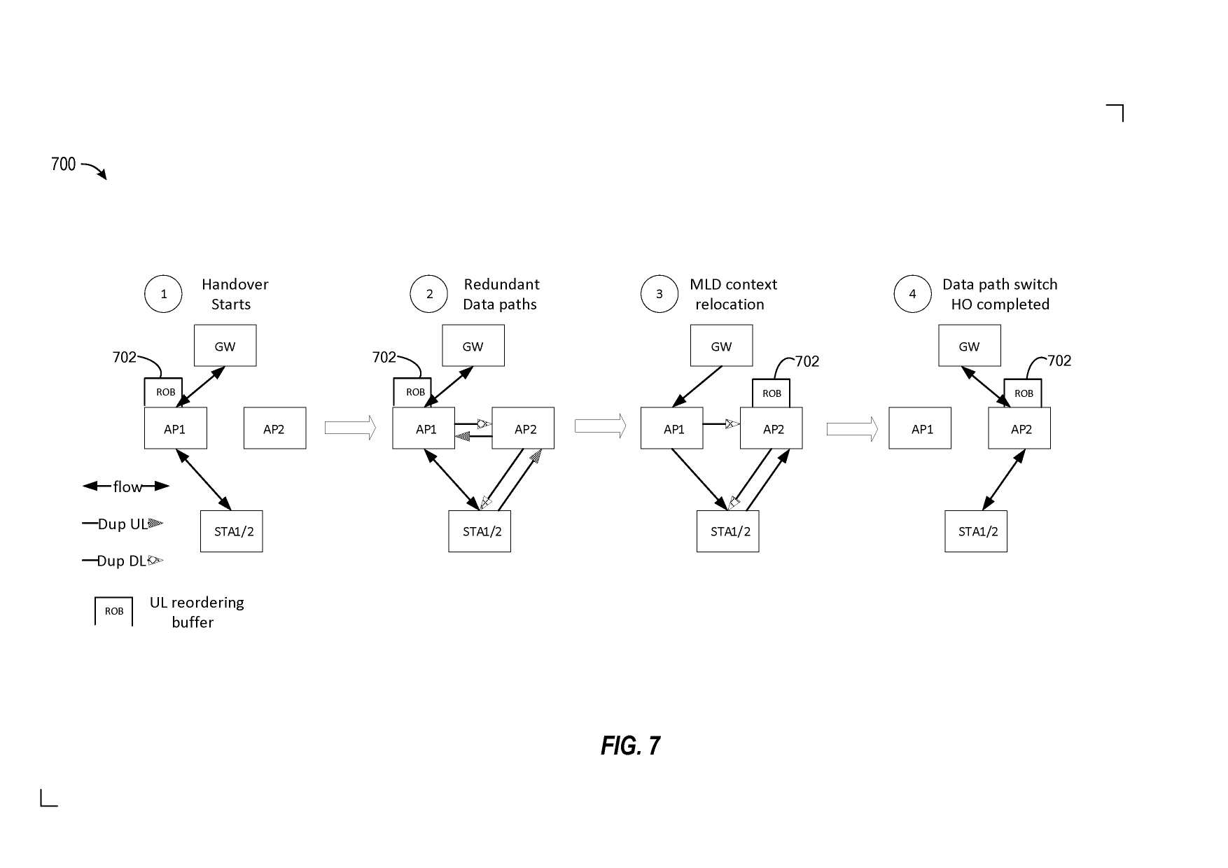

An example make before break-procedure is illustrated in FIG. 7. As illustrated, in an initial state (1), a gateway (GW) 704 may be connected to AP1, and all traffic goes through AP1. In this example, AP1 has an uplink (UL) reordering buffer (ROB) 702.

As shown at (2), handover to AP2 begins. First, downlink (DL) duplication is initiated where AP1 may start to duplicate DL packets, by forwarding the DL packets to AP2. Upon receipt, AP2 sends the DL packets to STA2. UL duplication may also begin when STA2 starts to duplicate UL packets and sends the dup to AP2, for example, over-the-air (OTA Sig 1). In one case, AP2 buffers all UL packets received at the ROB, without forwarding the packets to the gateway (otherwise, the packet may be received out of order at the gateway). In an alternative case, AP2 forwards all received UL packets to AP1 for reordering.

As shown at (3), after UL packets are forwarded, the MLD context may be relocated. MLD context location is based on agreed timer and an UL sequence number (SN) value, among other things. MLD context may comprise any of association context, security context, block-ACK (BA) sessions, TID-to-link mapping, a DL packets buffer, the ROB, and PN (packet number). During the MLD context relocation, AP1 terminates sending UL packets to gateway, then sends the MLD context to AP2, while STA1 may stop transmission to AP1 (OTA Sig2).

After relocation, at (4), AP2 may receive uplink packets and combine them with its local RO buffer. AP2 starts to send UL packets to the gateway, while AP2 stops forwarding UL packets to AP1 (if it has been forwarding the packets to AP1). In some cases, AP2 sends a “switch path layer 2 (L2) message” to the gateway, and the gateway switches data path to AP2. To finish the handover procedure, AP2 may send a handover “done msg” to AP1. AP1 stops DL transmission and clears any unsent DL packets.

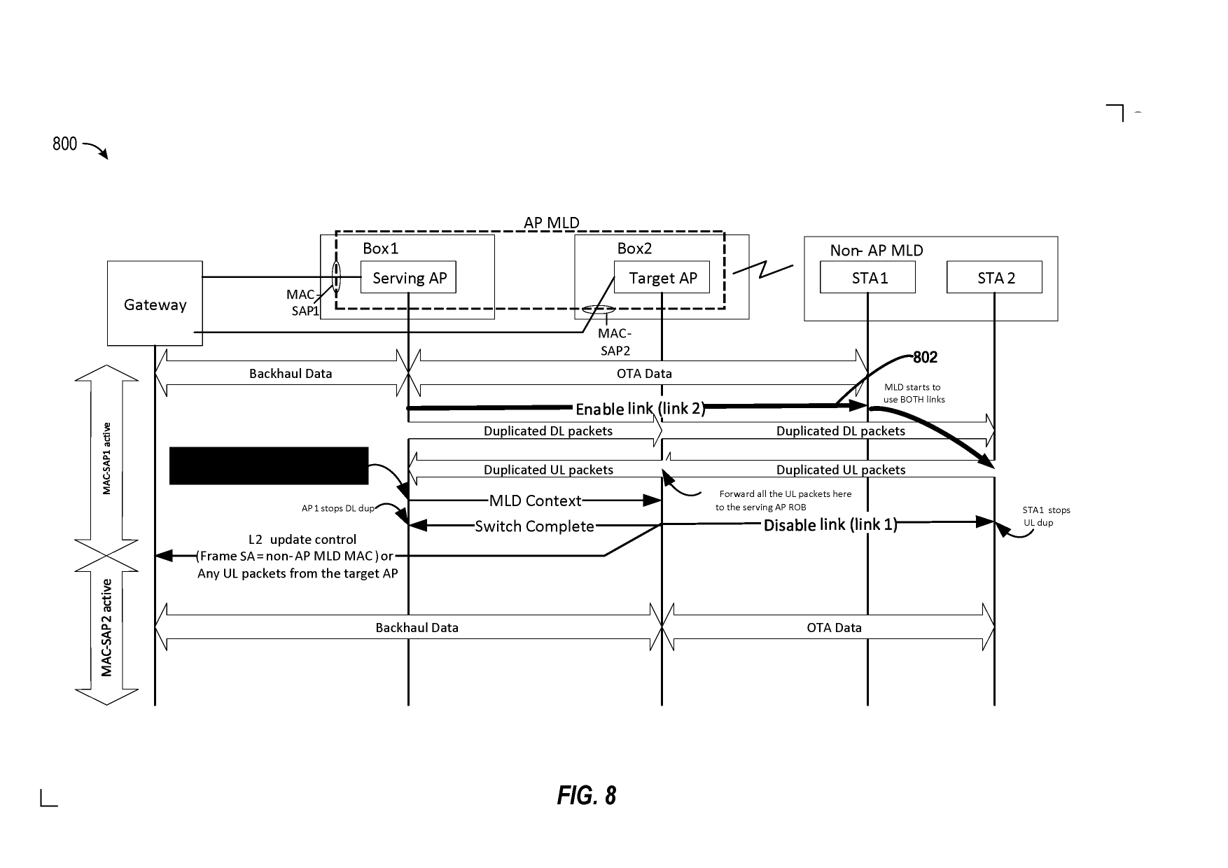

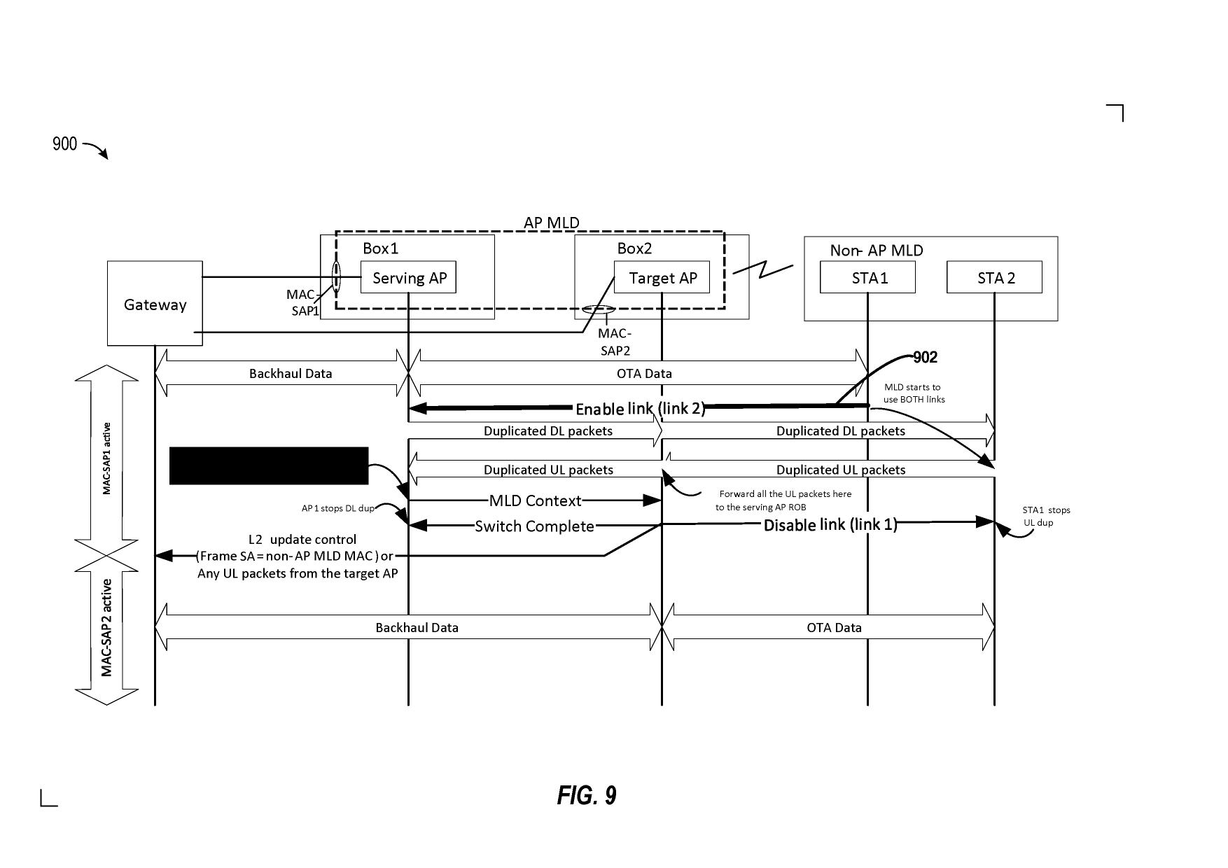

As illustrated in FIGS. 8 and FIG. 9, respectively, make-before-break handover may be initiated by the network or the client, respectively.

As illustrated in FIG. 8, assuming an initial state where the Non-AP MLD STA(s) are served by a serving AP (located at Box 1). In this case, the serving AP may initiate the handover by sending a message for the STA to enable a link to the target AP (in Box 2). The operations then proceed as discussed above, where the MLD starts to use both links during the handover. To signal an end of the handover, the target AP may send a message for the STA to disable Link 1 to AP1 and may send a message to AP1 that the switch is complete.

As illustrated in FIG. 9, for the client-initiated make-before-break handover procedure, the STA may send a message to the Serving AP to enable Link 2 to the Target AP. The other operations may proceed as described above, with reference to the network-initiated make-before-break handover procedure.

### Aspects Related to Early Termination of Roaming Transitory Period

Aspects of the present disclosure provide various signaling mechanisms that may help enhance transitory periods. For example, the signaling mechanisms may help support early termination of the transitory period.

As used herein, handover generally refers to the process of a wireless node moving from one (physically distinct) serving AP device, referred to as a source AP, to another serving AP device, referred to as a target AP. Other terms may also be used to refer to the same or a similar process, such as seamless roaming.

A wireless node being handed over (or roaming) from a source AP to a target AP could be any type of device that supports handover or seamless roaming, such as a non-AP MLD or a non-AP STA (e.g., a client device). The source AP and/or target AP could be any type of AP device, such as a standalone AP or an AP MLD.

In the handover scenarios described herein, the source AP and target AP may both be affiliated with a single mobility domain (SMD) management entity (SMD-ME). In this context, an SMD ME generally refers to a logical entity that comprises more than one non-collocated AP device such that a non-AP device that is associated with the SMD ME can seamlessly roam (e.g., without requiring reassociation) between the AP devices affiliated with the SMD ME. In this context, an AP device (affiliated with an SMD ME) can be an AP MLD which comprises one or more affiliated APs or a single link AP. A non-AP device can be a non-AP MLD which comprises one or more affiliated non-AP STAs or a single link non-AP STA.

The source AP and target AP may be affiliated with different (normal or non-SMD) AP MLDs. An SMD AP MLD may be similar to a normal AP MLD, in that it may control multiple APs affiliated therewith. One difference, however, is that APs affiliated with the SMD AP MLD may be in different locations (non-collocated), while APs affiliated to a same normal AP MLD are typically in the same location (collocated). In some cases, a non-AP MLD may use a seamless roaming procedure to roam between the AP MLDs of the SMD. A logical SMD-ME may provides association, authentication, and key management for non-AP MLDs across all AP MLDs of the SMD. A non-AP MLD may transition between AP MLDs within the SMD while maintaining its association and security association with the SMD-ME. The non-AP MLD may transition from one SMD to another SMD that are part of the same mobility domain (MD).

One example of an SMD ME is an SMD MLD, which may refer to a logical entity that can reside, for example, on a network controller or a serving AP MLD for a particular client. For the latter case, the physical AP that provides (activates/operates) SMD MLD functionality can be different for different clients and therefore the physical location of SMD MLD can be different for different clients. Further, some operations or functionality can be split between an AP MLD and an SMD MLD. For example, functionality related to association context, block acknowledgment (BA), and/or security may reside on the SMD MLD for a particular client, while other functionality related to a Link ID may be based on the serving AP MLD. This is in contrast to a conventional station (e.g., a legacy client) such as an 802.11 be compliant non-AP MLD, where such functionalities may all reside on the physical AP MLD that is serving the that non-AP MLD. While the present disclosure refers to an entity that provides the functionality described above as an SMD MLD, entities providing the same or similar functionality may be referred to by other names.

As noted above, when a STA initiates roaming (via an execution request/execution response handshake) from the current AP MLD (referred to as AP1) to the target AP MLD (referred to as AP2), the STA may be provided with a timeout (duration) of a transitory period.

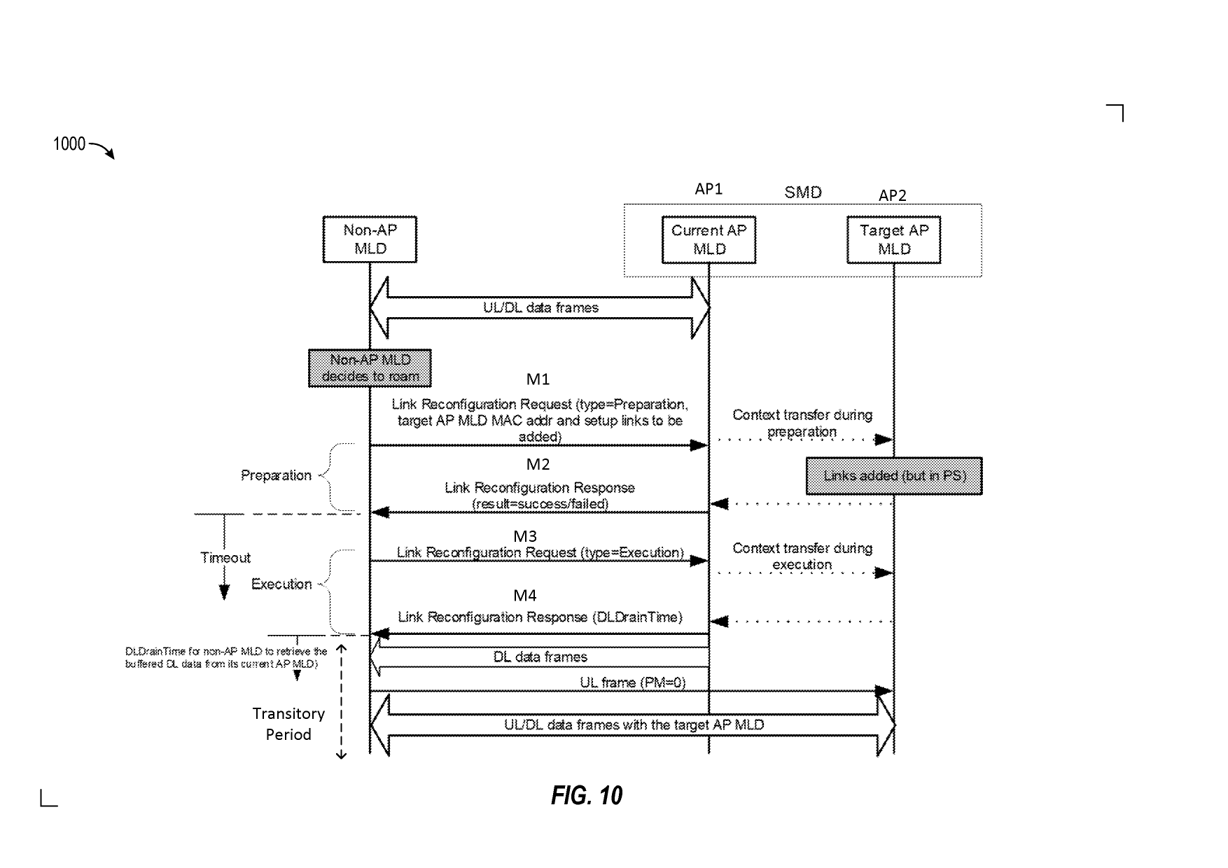

Operation during a transitory period may be understood with reference to the example call flow diagram 1000 of FIG. 10. The example assumes a client station (STA) that initiates a handover from a source AP (AP1) to a target AP (AP2), that are both affiliated with an SMD MLD.

As illustrated, the roaming may be divided into two phases, referred to as a preparation phase and an execution phase. In the preparation phase, the STA may initiate the roaming by transmitting AP1 a (link reconfiguration) request. AP1 may respond with a (link reconfiguration) response. In the execution phase, the STA may initiate transmit AP1 another (link reconfiguration) request. AP1 may respond with another (link reconfiguration) response.

As illustrated in FIG. 10, in some cases, the request and response in the preparation phase may be referred to as messages M1 and M2, respectively. Similarly, the request and response in the preparation phase may be referred to as messages M3 and M4, respectively

As illustrated in FIG. 10, the transitory period may begin with the execution response. A time period/duration of the transitory period may be provided as a timeout value (DL drain time) in the execution response.

During the transitory period (e.g., at any time after the execution response) the STA may awaken links with AP2 and start communicating via UL and/or DL. As illustrated, the transitory period may start with the reference execution response and may terminate at expiration of the (DL drain time) timer. During the transitory period, the STA may retrieve DL data from AP1.

AP2 may operate subject to certain constraints during the transitory period. For example, AP1 may also provides a BA window ‘split’ for each traffic ID (TID) that identifies the set of sequence numbers (SNs) that can be used by AP1 and AP2 respectively. AP2 may not be able to change the set of its allowed SNs before the transitory period is completed (allowing AP2 to change the set may confuse the STA that is still retrieving some DL SNs from AP1’s subspace).

In this manner, AP2 may be assigned for each TID a portion of the existing BA window, in terms of a set of allowed SNs. DL transmission of AP2 is confined to those SNs until the DLDrainTime expires or the termination indication signal from STA is received, whichever comes first.

After the transitory period, AP2 can use BAR and generally manage TIDs, and SNs without the constraints that are in place during the transitory period. For example, after the termination occurs, AP2 can send BAR frames to shift forward the BA window for any TID without restrictions, meaning that the can use all the SNs of the BA window for its DL (AP1 is assumed to not transmit DL to the STA anymore.

Aspects of the present disclosure provide various signaling mechanisms that may help enhance transitory periods. For example, the signaling mechanisms may help support early termination of the transitory period.

The signaling mechanisms proposed herein may include an AP1 to STA indication that the current AP (AP1) has no more downlink data (e.g., for one or more traffic identifiers (TIDs) or across all TIDs, and no further downlink data is buffered or expected), which may be beneficial by aiding the STA in deciding to terminate the transitory period early and complete the move to AP2. The signaling mechanisms proposed herein may also support STA to AP2 indication of ‘early termination’ which may be beneficial by helping to release the target AP (AP2) from constraints that AP2 is subject to during the transitory period. The signaling mechanisms proposed herein may also support STA to AP1 indication of ‘early termination’ which may be beneficial by releasing AP1 from unnecessarily transmitting DL data.

As noted above, AP1 may signal an indication to STA that it has no more DL (a “no more DL” indication). In some cases, the indication may be provided via data and/or control frames, because AP1 may already be transmitting DL to the STA. Management frames could be used, but might be avoided in some cases. This is because STA may start communicating with AP2 at any time and receive management frames from AP2, so to not confuse the STA (AP1 and AP2 are not assumed to continuatively synchronize the SN that they would use for Management frames). Thus, in some aspects it may be assumed that AP1 will refrain from transmitting any management frame to the STA after the execution response frame.

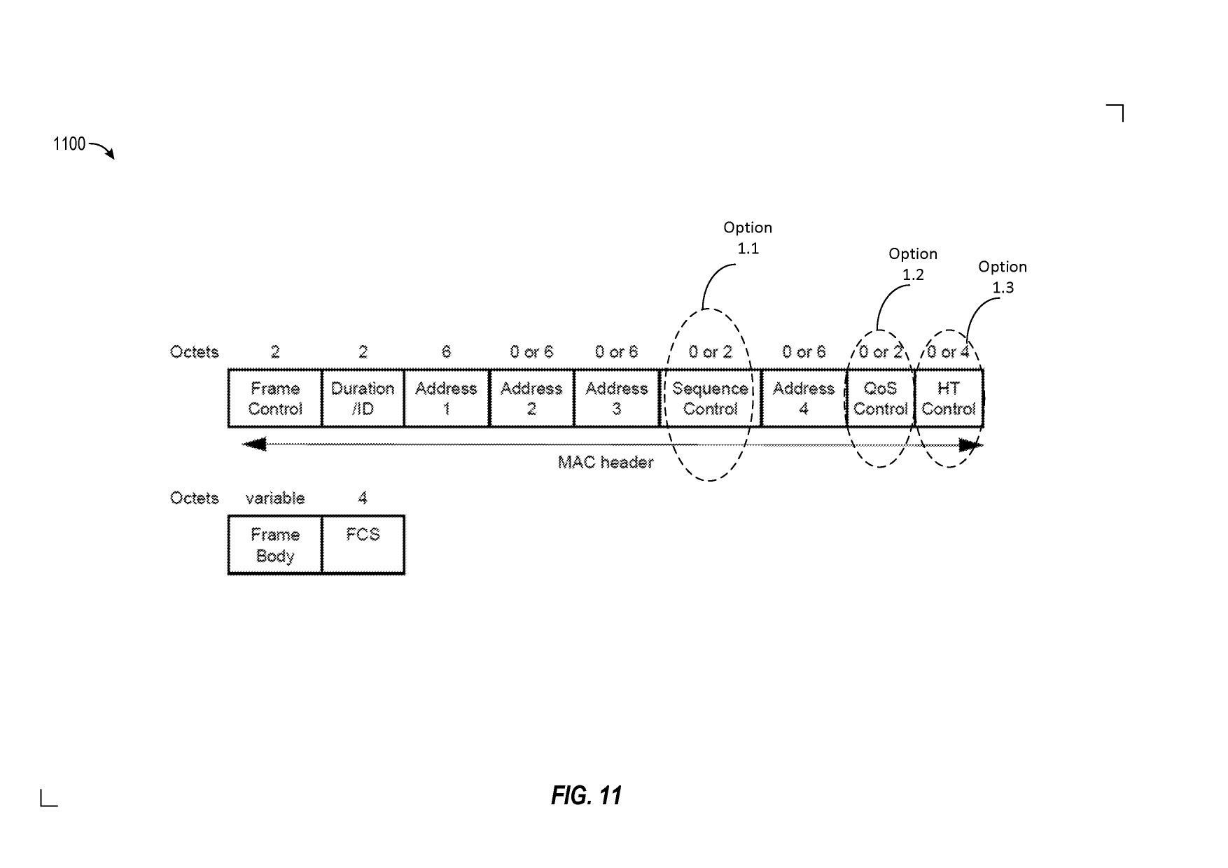

As illustrated in diagram 1100 of FIG. 11, various options for providing the no more DL indication involve fields of a MAC header (e.g., of a QoS Data or QoS Null frame). For example, according to one option (Opt1.1), a More Data subfield (of a sequence control field) is repurposed for UHR STAs to provide the indication. According to another option (Opt1.2), one or more bits of a QoS Control field may be used. According to another option, (Opt1.3), one or more bits in an A-Control field of an HT control field may be used.

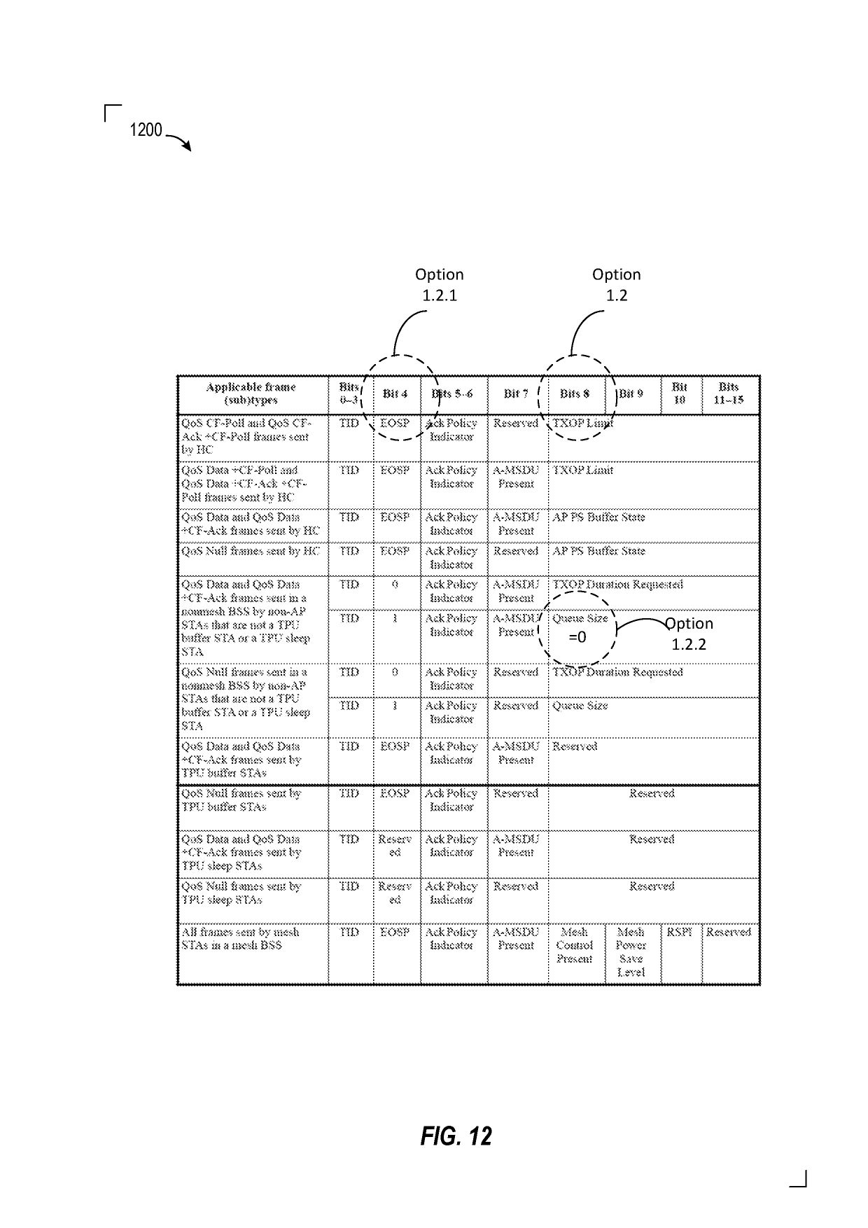

Diagram 1200 FIG. 12 illustrates examples according to Opt1.2, by defining applicability for frame types (QoS Data, QoS Null, sent by AP STA) and reuse one of the bits for ‘no more DL’ (e.g., Bit 8). As illustrated, according to one option (Opt1.2.1), an end of service period EOSP field (b4) may be used. According to another option (Opt 1.2.2), a queue size may be set to 0 (indicating that no buffered DL data remains and no further DL data is pending). According to another option (Opt 1.2.3), an End of TXOP Service Period EOTSP field may be used.

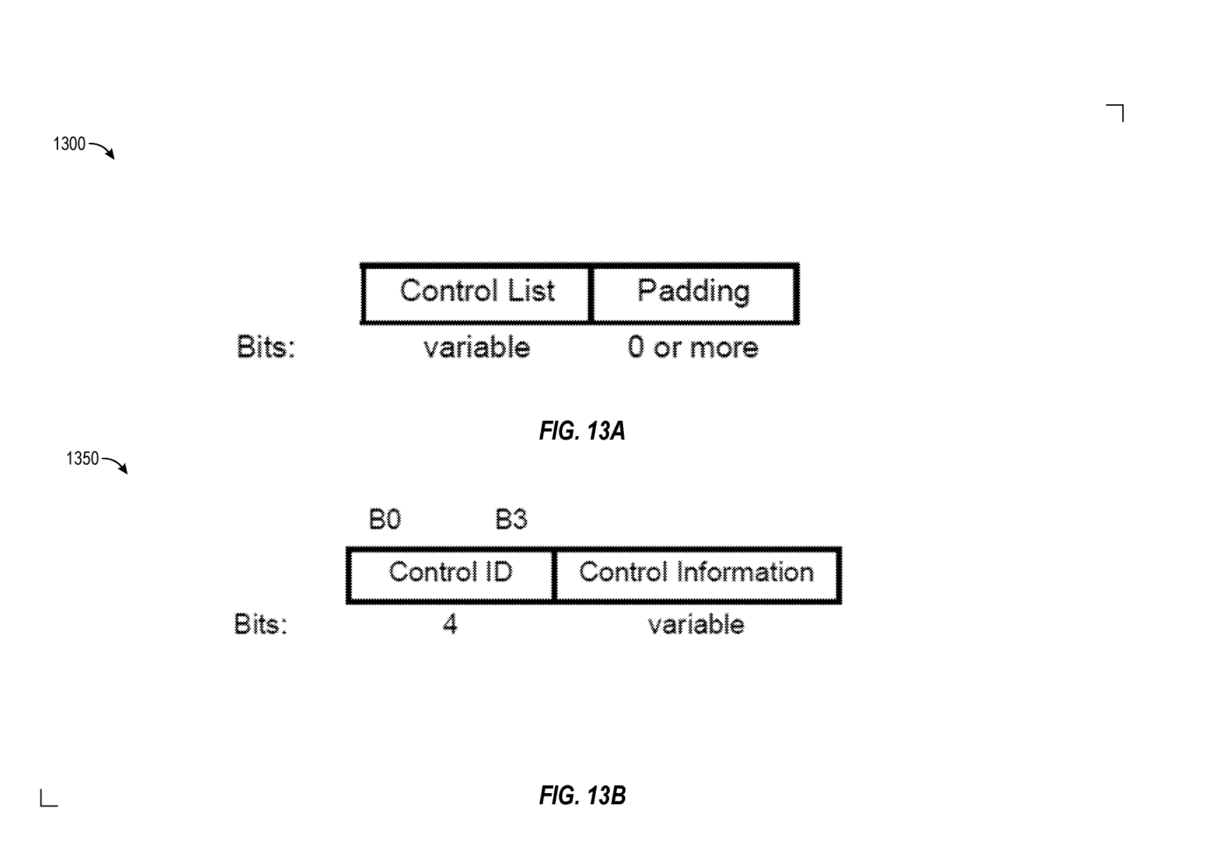

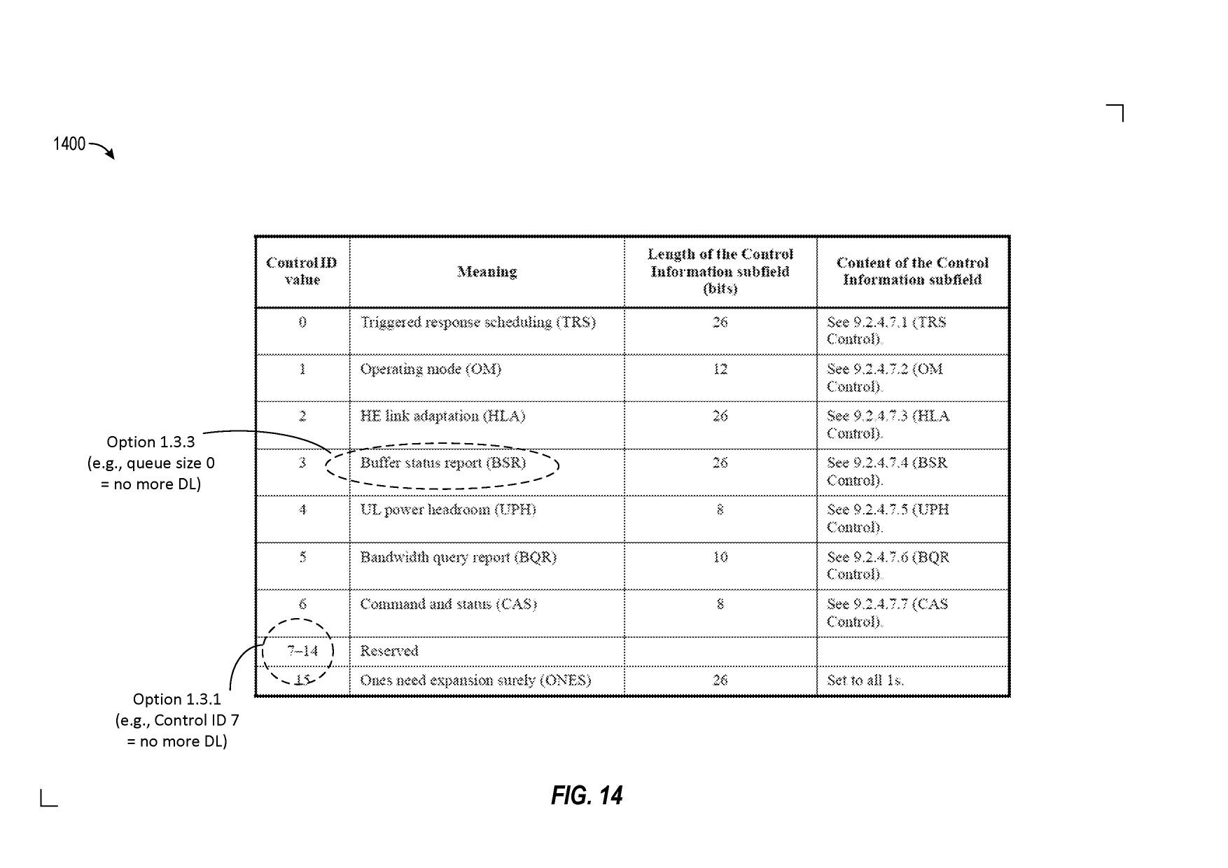

According to one option (Opt1.3.1), a new Control ID value (e.g., 7=‘no more DL’ as indicated in diagram 1400 of FIG. 14) may be used and/or a Control subfield may be added in a Control List field (see 1300 in FIG. 13A) of the HE variant of the HT Control field of the MAC header.

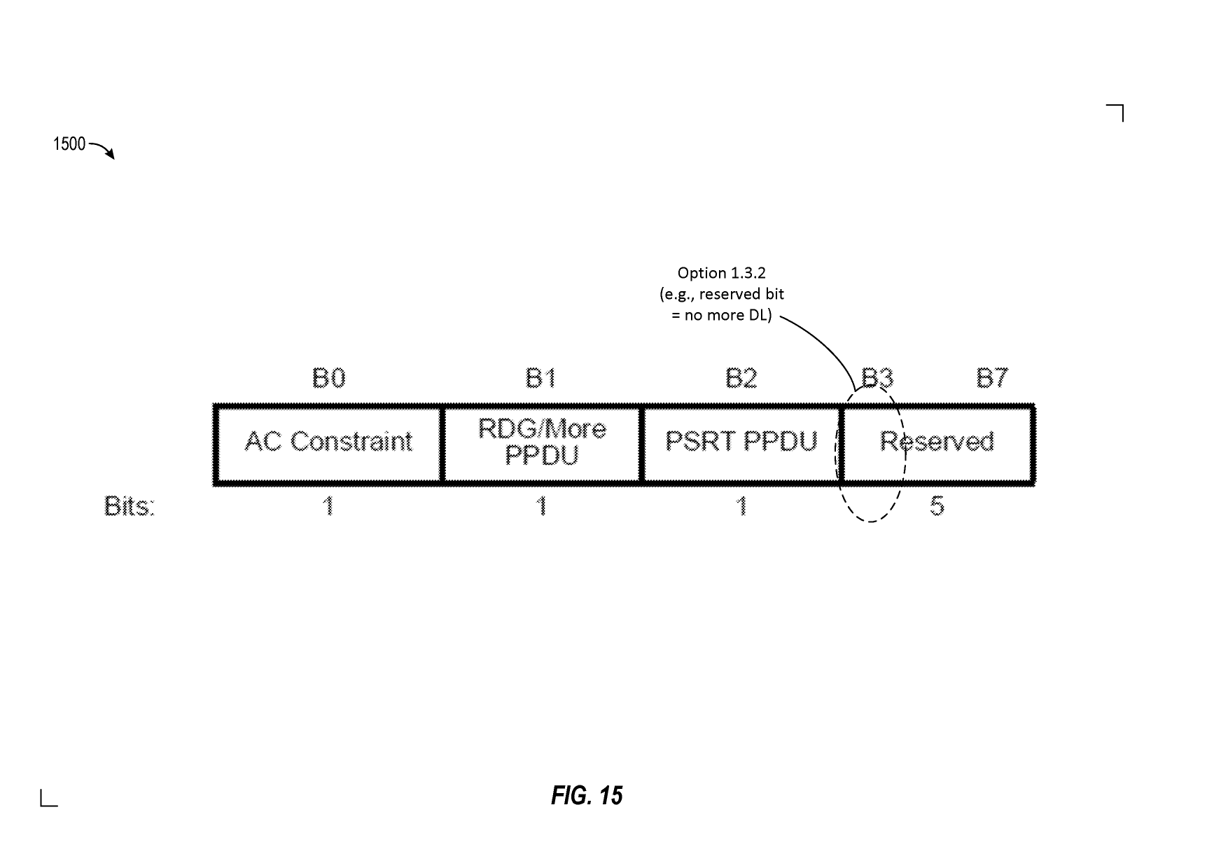

Additionally Control Information field can carry an estimation of the queue size (in this option instead of ‘no more DL’ it would be ‘DL buffer status’). According to one option (Opt1.3.2) reserved bits in a CAS control field may be used (as illustrated in diagram 1500 of FIG. 15).

According to another option (Opt 1.3.3) bits in a BSR control field may be used (e.g. setting queue size =0). This indication may provided per access class (AC) but, in general, setting to 0 for all may indicate ‘no more DL’ across all ACs for the STA.

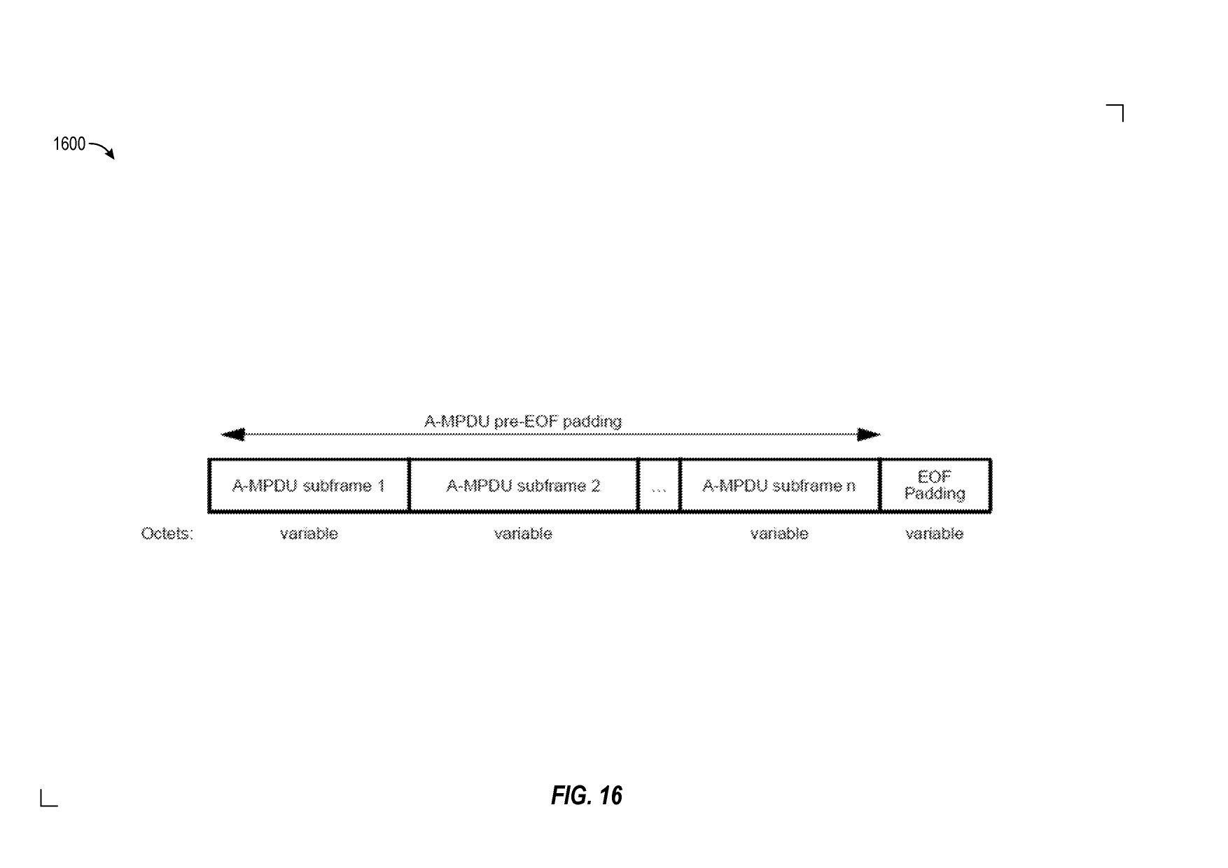

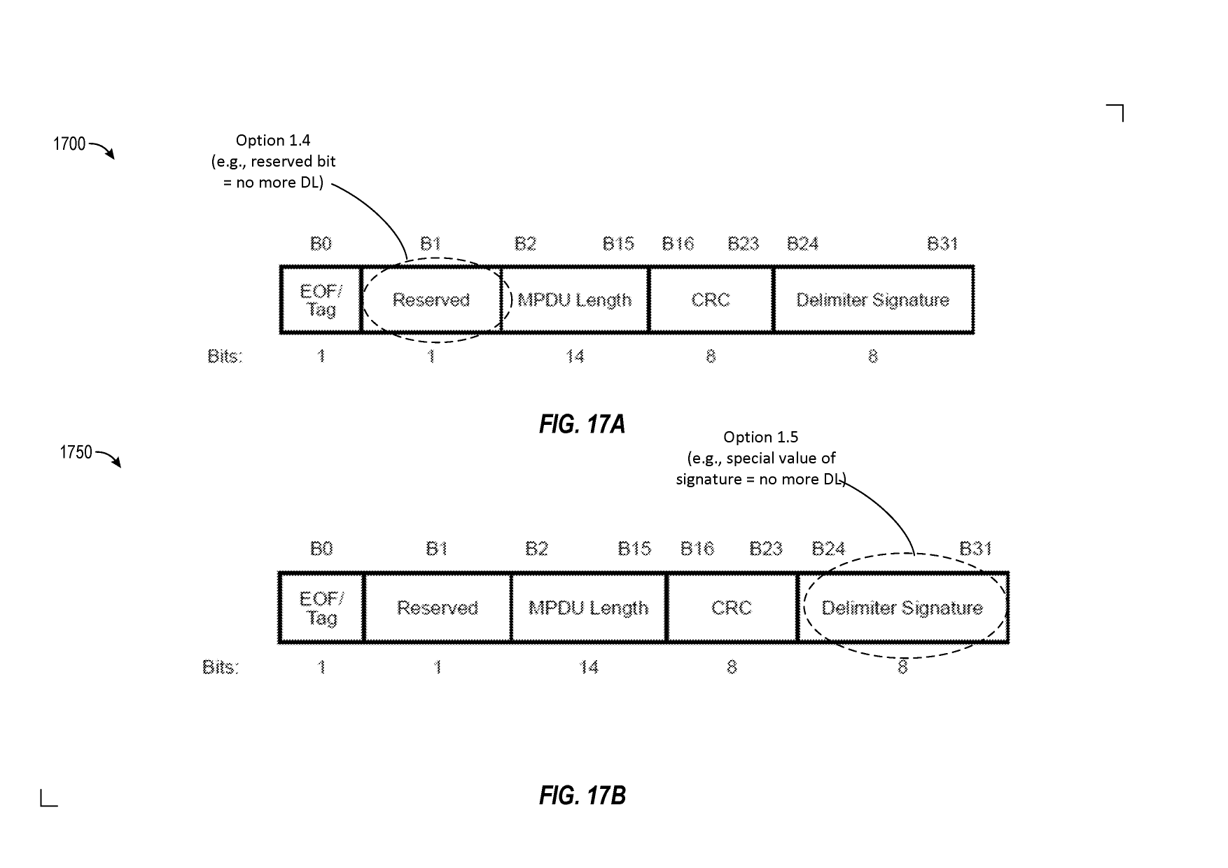

Diagram 1600 of FIG. 16 illustrates a sequence of A-MPDU subframes. In some cases, AMPDU delimiters may be placed between MPDUs. According to one option (Opt1.4) as indicated in diagram 1700 of FIG. 17, an AMPDU delimiter reserved bit may be used for the indication. According to one option (Opt 1.5) the delimiter signature may be used for the indication (e.g., via a special value).

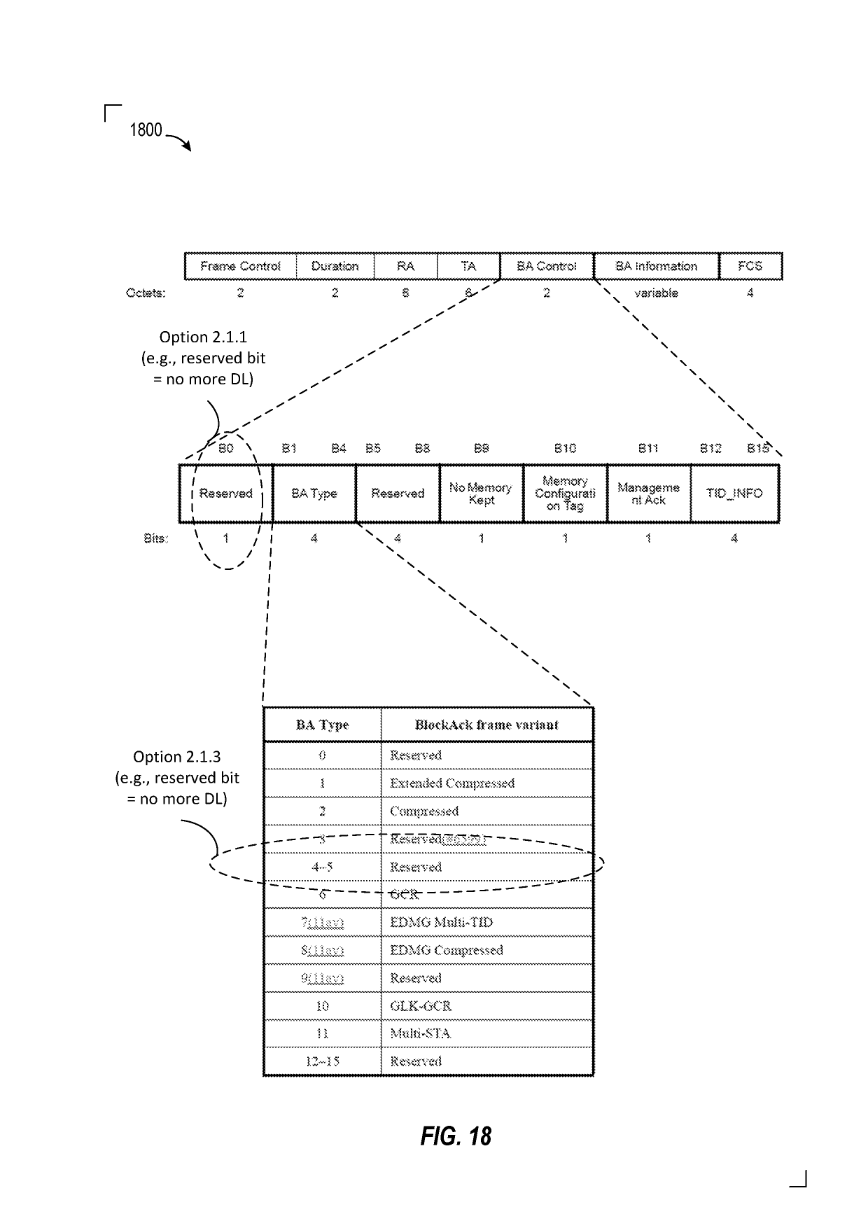

According to certain options (Opt2), a control frame may be used to provide the no more DL indication. As illustrated in diagram 1800 of FIG. 18, according to one option (Opt2.1) a BA frame may be used. According to one option (Opt2.1.1) a reserved bit in a BA Control field may be used. According to another option (Opt2.1.2) a reserved bit in an existing variant of BA frame may be used. According to another option (Opt2.1.3), a new BlockAck frame variant may be defined (e.g., defining a format including a field to report ‘no more DL’).

According to one option (Opt2.2), bits in a multi-STA block ack (MBA) frame variant may be used. For example, according to one option (Opt2.2.1), bits in Feedback User Info field of the MBA frame may be used.

According to one option (Opt2.3), bits in an initial control frame (ICF) may be used for the indication. For example, according to one option (Opt2.3.1) bits in a user info field that carries the AID of the STA may be used to signal no more DL.

According to one option (Opt2.3.2), a special user info field value (e.g., AID=2007) may be used for the indication. According to one option (Opt2.3.3), a special value in a Feedback user info field (e.g., AID=2008) may be used for the indication. . According to one option (Opt2.3.4), a common info field may be used for the indication, for example, if a unicast ICF, as for example a non-trigger based (NTB) BSRP trigger frame.

As noted above, the signaling mechanisms proposed herein may also support STA to AP2 indication of ‘early termination’ which may be beneficial by helping to release the target AP (AP2) from constraints that AP2 is subject to during the transitory period.

One option for STA to AP2 early termination indication (Opt1) is to use an indication in MAC header of a QoS Data, QoS Null frame, or Management frame. The various signaling options described above with reference to the “no more DL” indication from AP1 to the STA may also be used to provide the indication early termination (explicitly indicating that DL draining is completed or the DL draining period is terminated) from the STA to AP2. For example, the various options involving control frames (e.g., Opt2) may also be used.

According to certain options (Opt3), the frame body of a management frame exchange may be used to provide the indication of early termination (explicitly indicating that DL draining is completed or the DL draining period is terminated) from the STA to AP2. According to one option (Opt3.1) new management frames may be defined for request/response of early termination of transitory, which may require to define an element or a field to carry the indication. According to one option (Opt3.2), an indication may be piggybacked in existing frame exchanges (e.g. and use reserved bits in already defined elements/fields).

As noted above, the signaling mechanisms proposed herein may also support STA to AP1 indication of ‘early termination’ which may be beneficial by releasing AP1 from unnecessarily transmitting DL data. The various signaling options described above with reference to the “no more DL” indication from AP1 to the STA may also be used to provide the indication early termination (explicitly indicating that DL draining is completed or the DL draining period is terminated) from the STA to AP1. In such cases, however, different names may be used for the fields.

According to certain aspects, when a field from the above options is used to provide an indication, the same field can be used in either direction flexibly to provide either ‘no more DL’ or ‘early termination’ indications. For example, if such a field is used for the indication, AP1 may use it to indicate ‘no more DL from AP1’ while AP2 may use the same field to indicate ‘no more DL from AP1, sending this on behalf of AP1’ (e.g., assuming AP1 and AP2 can synchronize on when the DL draining is completed on AP1’s side, and AP2 bridges this info to STA). This same field may be used by the STA to indicate early termination.

According to certain aspects, one or more of the indications described above may be provided as per TID operation. For example, the ‘no more DL’ and ‘early termination’ indications proposed herein may be associated to specific TIDs. In such cases, for example, the STA can signal early termination for specific TIDs. To indicate such TIDs, the fields where the indication is reported may also include the indication of the TIDs. According to one option, the field may include a list of TIDs. This approach be aided by a list size, or a ‘more TID’ subfield associated to each TID in the list (each TID would have a subfield with a ‘more TID’ bit and a subfield with the TID itself). According to another option, a bitmap of a certain size may be used indicating which TIDs (assuming that a bit in position 2 will refer to the second TID existing between AP and STA). In some cases, these fields may help dictate behavior of an AP2 upon receiving these early termination indications. For certain TIDs, AP2 may be managing a BA window without constraints for those TIDs.

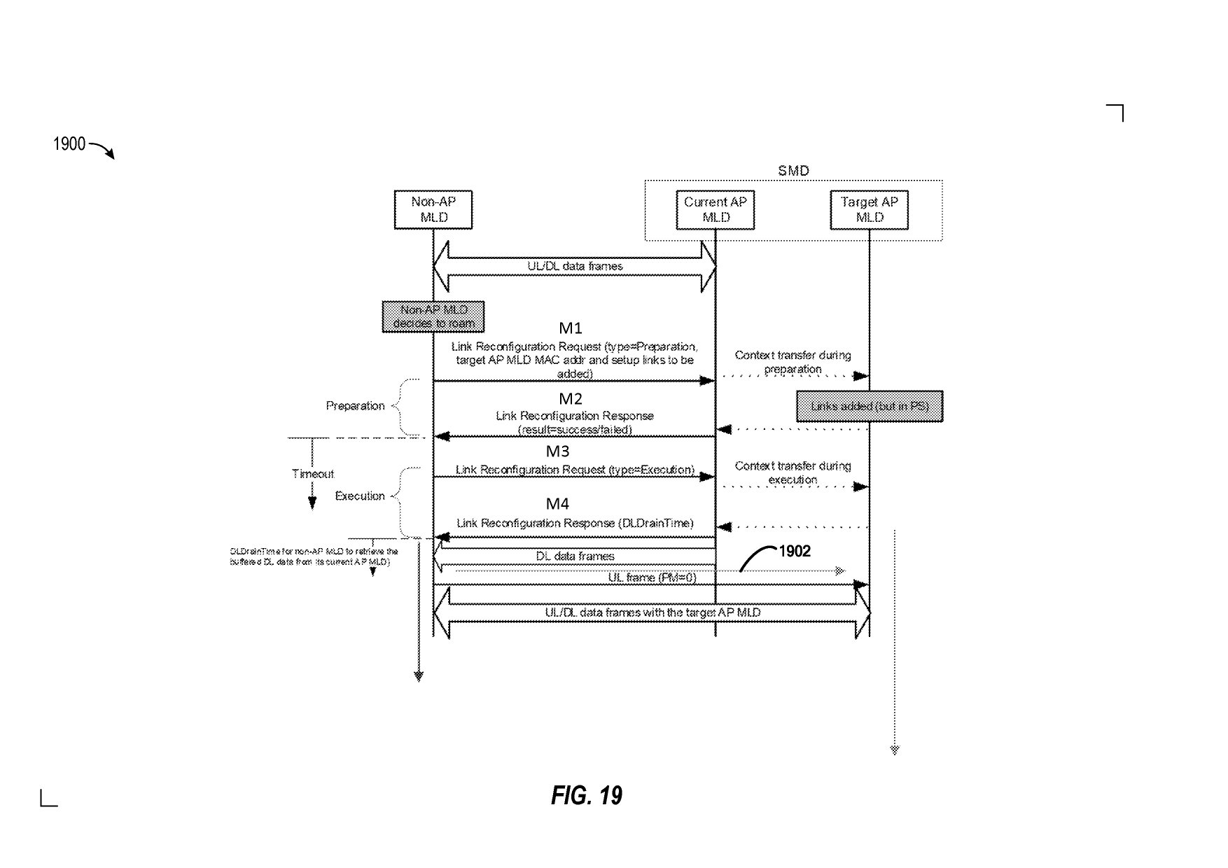

Referring to call flow diagram 1900 of FIG. 19, when M3 is received by AP1, AP1 may notify AP2 and transfer the context over backhaul, so that AP2 is aware of the roaming execution before M4 is sent.

In such cases, AP1 may need to provide the timer value and the BA window split to AP2, which may be determined in a later stage (e.g., just before M4 is ready to be sent). Therefore, there may be somewhat of a ‘competition’ between the notification over the backhaul (AP1->AP2) and the notification over the air (OTA AP1->STA via M4). This means that if the backhaul round trip time (RTT) for the notification is larger than the timeout, STA might be left waiting for something to happen (e.g., has received all pending DL from AP1, timer expires, and no BAR is sent by AP2 to move forward the BA window for new transmissions with new SNs).

It may be noted that the absence of the timer value at AP2 may not imply that AP2 cannot transmit/receive in the meantime. To transmit, AP2 may need to know the BA window split (and the SNs that AP2 can use) which, in some cases, might be indicated more in advance between M3 and M4 (in the worst case scenario STA sends an UL with PM=0 indication to have AP2 kick off DL scheduling but if AP2 has not received the allowed SNs from AP1 cannot start yet). To receive by AP2 may be less complicated, as long as AP2 is notified of the roaming execution and context is transferred early between M3 and M4 any UL from STA can be received.

As indicated at 1902, according to certain aspects, STA may send an ‘early termination’ indication to AP2 at the expiration time of the transitory (to make sure that AP2 is unlocked for sending BARs that move the BA window forward and knows that DL draining from AP1 is concluded). This approach may provide some type of safety against additional delays for scheduling new data on AP2 side.

In some cases, certain mechanisms may be provided to help ensure backhaul communications meet delays (and DL from AP2 being delayed due to missing info of BA window split and/or transitory duration at AP2), so that STA may be able to bridge the gap. According to certain aspects, after the STA receives M4 containing the BA window split per TID, and the transitory duration (timer), the STA may send an UL transmission to AP2 to report this information. For example, this information may be carried in an existing element that is enhanced for this purpose (e.g., Multi-Link Information element) or in a new element dedicated for the purpose.

The information carries a field for the timer value, and a list of fields (one per each TID), for each TID the field contains the TID and the BA window parametrization in terms of SNs allocated for AP1 and SNs allocated for AP2 (e.g. SNstart_AP1, SNend_AP1, SNstart_AP2, SNend_AP2, as an example, but the split can be defined in other ways). This may provide greater flexibility, as conventionally, AP2 may be constrained to operate within the boundaries of its portion of BA window for each TID (e.g. and is unable to send a BAR frame indicating a shift forward).

According to certain aspects, messages M1-M4 may include an indication of a ‘type’ of Link Reconfiguration Request/Response frames (e.g., for roaming: preparation or execution). For example, the indication may indicate a type of a link reconfiguration message is for roaming. For example, in roaming, the following EHT protected frames may be used:
M1: Link Reconfig. Request (Preparation);
M2: Link Reconfig. Response (Preparation);
M3: Link Reconfig. Request (Execution); and
M4: Link Reconfig. Response (Execution).

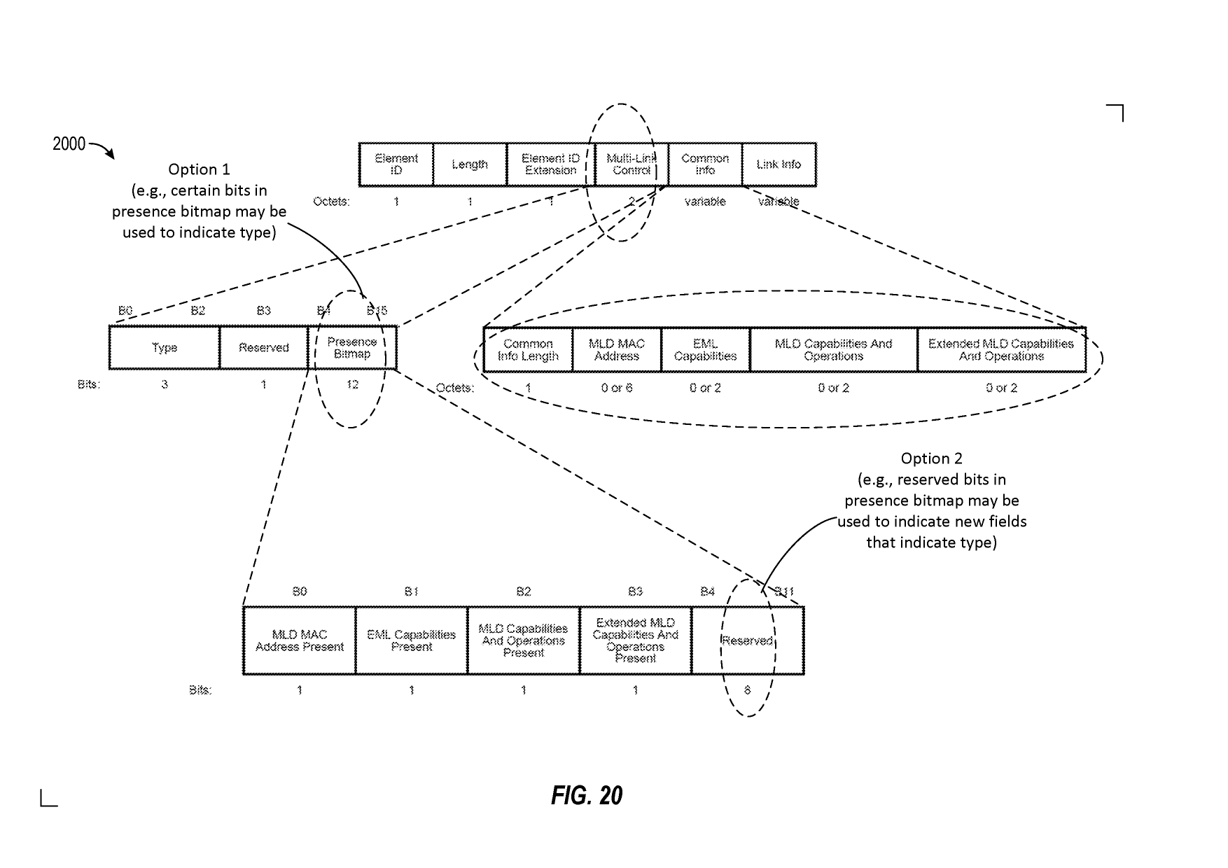

Aspects of the present disclosure provide an indication for the type to distinguish the 2 phases of roaming (preparation/execution), and to distinguish those from regular Link Reconfig Request/Response to/from AP1. According to certain aspects, as illustrated in diagram 2000 of FIG. 20, one or more bits in an ML Control and/or Common Info fields may be used to provide the type. According to one option (Option 1), the Presence bitmap in ML Control field is shrunk (redefined with fewer bits) and the newly carved bits (that were previously part of Presence Bitmap and reserved therein) may be dedicated to indicate the type (e.g., Preparation v execution). According to another option (Option 2), one or more reserved bits in the presence bitmap may be used to indicate presence of new field(s) in Common Info, which indicates the type.

According to certain aspects, the type indication may be provided via new UHR Protected (category) frames, new actions, or frame subtypes (e.g., Regular Link Reconfiguration, Preparation, Execution) in a field in the frame format. According to certain aspects, certain specific actions may be defined for each frame (e.g., with no subtypes), such as:
Cat=UHR Protected, Action = Link Reconfig Request;
Cat=UHR Protected, Action = Link Reconfig Response;
Cat=UHR Protected, Action = Preparation Request;
Cat=UHR Protected, Action = Preparation Response; Cat=UHR Protected, Action = Execution Request; and
Cat=UHR Protected, Action = Execution Response.

According to certain aspects, the Category=UHR Protected, Action= Link Reconfig Req/Resp, and a new field in a frame format Type=[preparation, execution, ...] may be used to indicate the type of Link Reconfig Request/Response in the category UHR Protected. In such cases, two types may be defined for roaming and more types may be defined for this category and actions, such as:
Cat=UHR Protected, Action = Link Reconfig Request; Type=Preparation;
Cat=UHR Protected, Action = Link Reconfig Response; Type=Preparation;
Cat=UHR Protected, Action = Link Reconfig Request; Type=Execution; and
Cat=UHR Protected, Action = Link Reconfig Response; Type=Execution.

According to certain aspects, various AP MLD level information for roaming may be provided in ‘Link Reconfiguration Response’ frames (e.g., either preparation or execution). For example, assuming the link reconfiguration framework described herein, EHT Protected Management frames (category) and Link Reconfiguration Request/Response frame (Action) may be used.

As in conventional link reconfiguration, these frames may be used to add Link operation via Multi-Link Information elements and Per-Sta Profile subelements, which may be used to carry the per-STA profiles and the bits for requesting link addition, as well as provide responses on acceptance.

Preparation and Execution has also new tasks for roaming, as described herein. As a result, it may be beneficial to provide additional information (e.g., by the STA and/or one of the APs).

Examples of such information include per-MLD information (overall proposal in next slides is adding a new element after ML IE in relevant frames OR define a Per-MLD Profile subelement to be carried next to the already existing Per-STA Profiles in the ML IE carried in the frames).

Such per-MLD information may include security keys establishment. This may include Nonces, DHSs parameters, and message integrity checks (MICs). This information may be provided since there are 2 modes for security (one with shared PTK and one with per AP-MLD PTK), there is a need to convey parameters to perform and validate a new PTK between M1 and M4 (parameter may include a mix of Nonces, Diffie-Helman shared secret parameters for perfect forward secrecy (as public ephemeral keys), MIC fields for key validation).

Per-MLD information may also include the DLDrainTime (the transitory duration). While this information may be unique for all TIDs (e.g., as “All-TIDs Information”), in some cases it could be provided per TID (e.g., as a “Per-TIDs Information Set”). In some cases, different (per-TID information) fields may indicate whether DL data is completed (drained) for a corresponding TID. Such information may be provided in M4, at least in the case when M3/M4 are exchanged with Current AP MLD (AP1). In another case (e.g., M3/M4 exchanged directly with AP2), this information might be less relevant, for example, as it may be unlikely that STA is interested in retrieving DL during a transitory period with AP1, since the STA might have switched channel and tuned on AP2’s links already. Thus, the transitory duration may be considered zero for this case.

Per-MLD information may also include the target AP MLD MAC address (e.g., because Preparation exchange is a way to add Links of a Target AP MLD via the handshake M1-M2 with the Current AP MLD (AP1)). In some cases, AP1 may communicate with AP2 over backhaul to convey the request/response to add those links of AP2 to the ML setup links of the STA. Also, execution messages may be sent to AP1, so the target AP2 may need to be indicated as well. This indication may be included in M1 and M3 messages.

Per-MLD information may also include an indication from the STA to request to NOT transfer Next SN for AP2 (e.g., in practice the boundary for AP2 in the BA window split): per-TID (or a single indication for ALL TIDs), per direction (UL/DL). This means that (if indicated), AP2 may be in full control of the BA window management for the TIDs, the BA windows may not be split, and the transitory period may either be a duration of 0 or close to 0, and AP2 can reset the SNs for those TIDs and that direction (e.g. restart from SN=0). This indication may be provided in M1 and M3 messages.

Per-MLD information may also include the next SN that the target AP MLD (AP) will use for DL. This information may be per TID, so multiple values in a list (e.g., 12 bits per TID) may be provided in the M4 message (or could be for all TIDs).

Per-MLD information may also include parameters of SCS agreements, which may include information regarding rejected Stream Classification Service (SCS) agreements (e.g., a list of SCS IDs and a flag indicating supported/discarded for each SCS ID), since the SCS agreements may be part of the transferable context. This information may be provided for M4 and possibly for M2 messages. In some cases, AP2 may update parameters of SCS agreements. From a STA perspective, this information may be for prioritization of SCSs in case AP rejects some. From an AP perspective, this information may include accepted/rejected information, based on the existing SCS agreements (transferred from AP1 and AP2). In some aspects, decisions to accept/reject can be based on the prioritization info provided by STA.

Per-MLD information may also include information on prioritized SCS agreements (e.g., as an ORDERED list of SCS IDs). Since the SCS agreements are part of the transferable context, a STA may indicate which are the most important ones in case AP2 cannot support all. This information may be provided for M3 and possibly for M1 messages.

Per-MLD information may also include parameters of BA agreements, such as shortened maximum (Max) BA window size. For example, the value may be shortened because the STA might have been using a longer one with AP1. This information may be indicated only if the value with AP2 is shorter (if longer values are available, the STA can negotiate with AP2 after roaming). This information may be provided for M4 and possibly for M2 messages (and may be per TID).

Per-link information may also be provided. Such information may be considered an extension of Per-STA profiles in an ML IE to carry the new information. Per-link information may include, for example, BSS color.

Aspects of the present disclosure provide various signaling proposals for indicating the previously described per-MLD information.

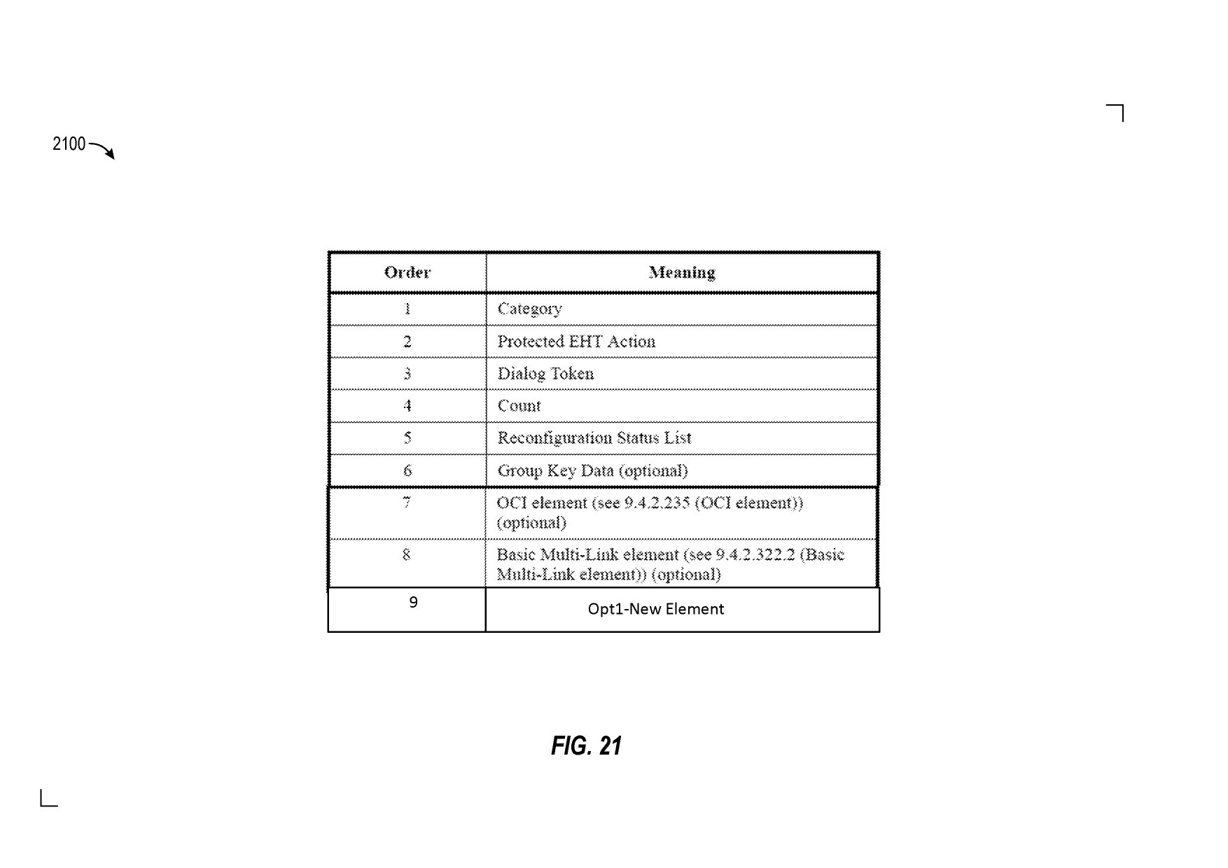

For example, as illustrated in diagram 2100 of FIG. 21, according to a first option (Opt1) a new element may be defined (e.g., with Order 9). For example, this element may be carried in the Link Reconfig Request/Response frame with Type ‘Preparation’ and or ‘Execution’ described above. Such an element may be included, for example, in a BSS transition management (BTM) Query/Request for BTM recommendations. In such cases, the element may be used to carry a subset of th types of information described above.

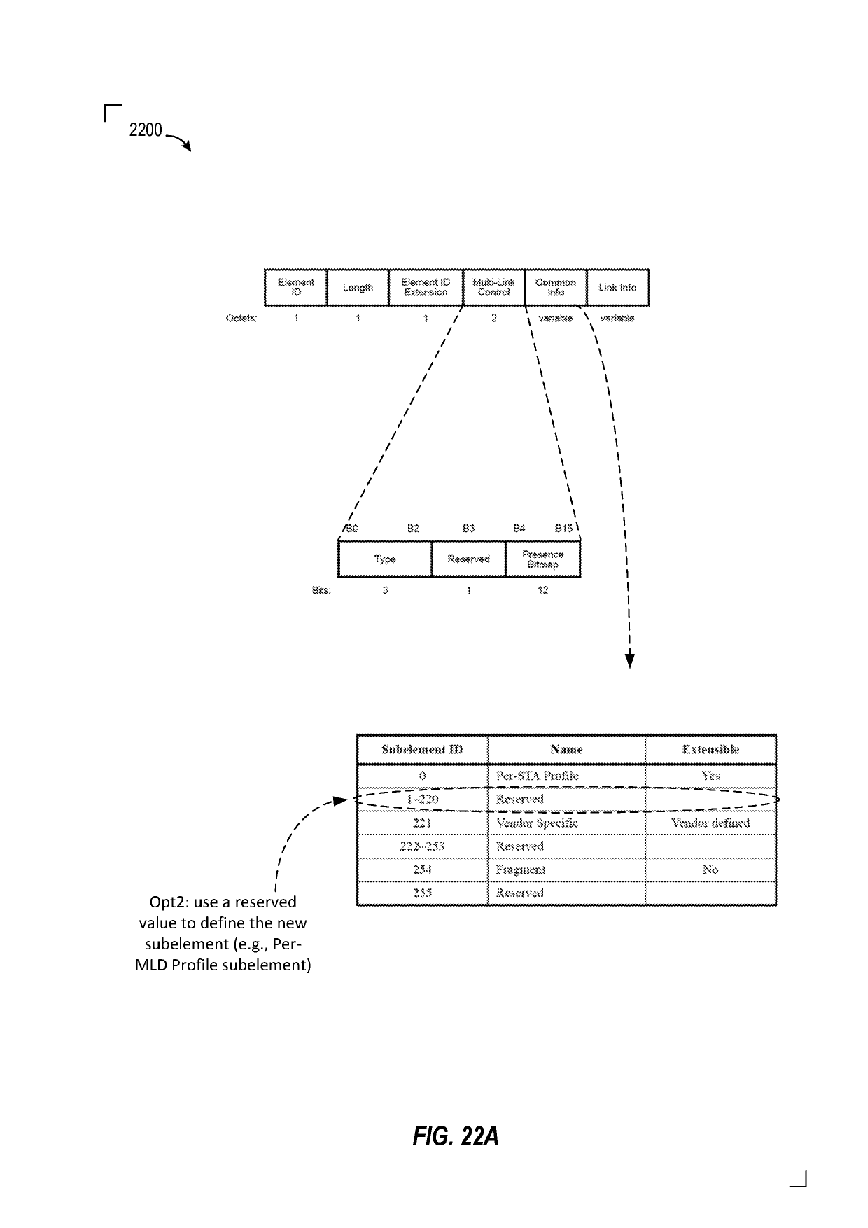

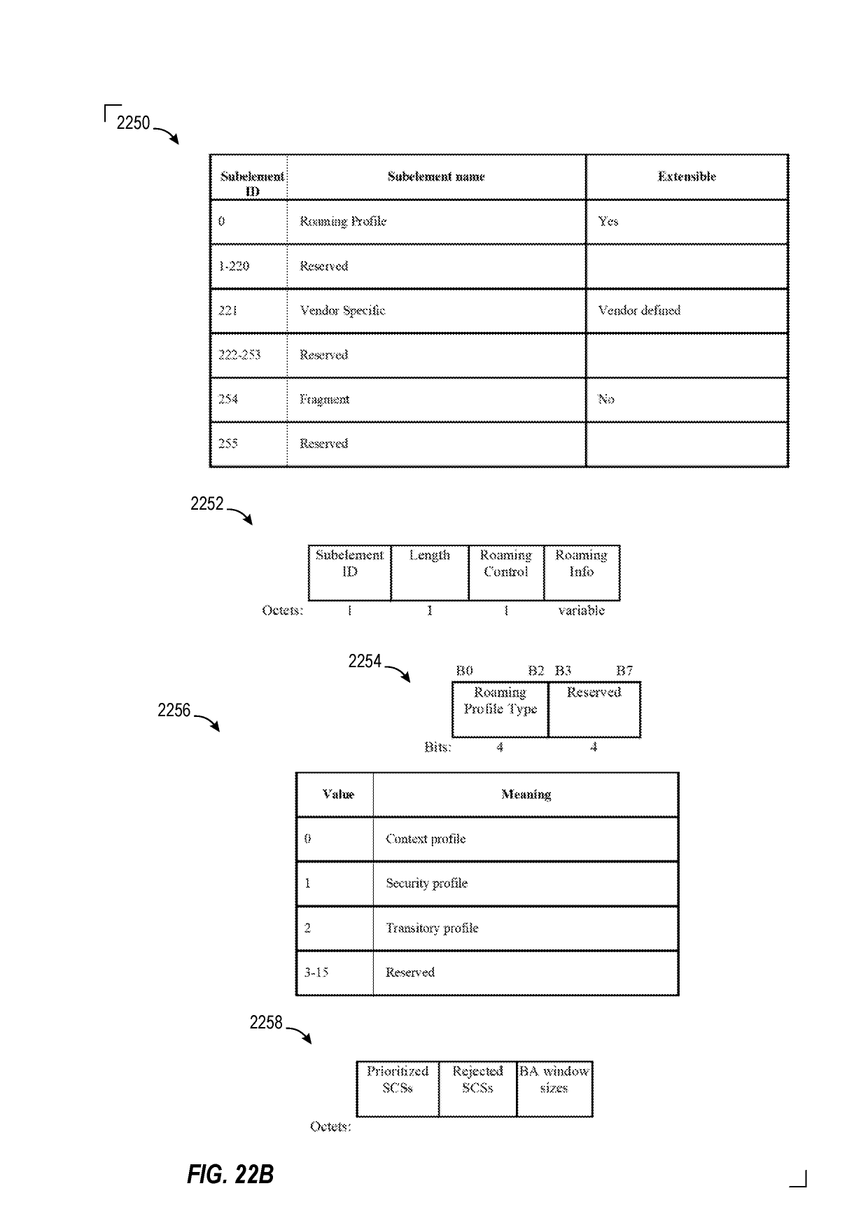

Per-MLD information described above may be conveyed in a new element (Opt1) or in a new sub-element (Opt2). As illustrated in diagram 2200 of FIG. 22A, a new subelement (e.g., Per-MLD Profile) may be included alongside Per-Sta Profile subelements in the Link Info field of the ML element. As illustrated, a reserved value may be used to define the new subelement (e.g., Per-MLD Profile subelement). In some cases, the new subelement may be carried in the Link Reconfig Request/Response frame with Type ‘Preparation’ and or ‘Execution’ as described above.

FIG. 22B illustrates an example 2250 of optional subelement IDs of a roaming information field and an example roaming profile subelement format 2252 having a roaming control field. FIG. 22B also illustrates an example roaming control field format 2254 having a roaming profile type field and a table 2256 with example roaming profile type field values. As described above, and indicated at 2258, per-MLD information may also include information regarding rejected Stream Classification Service (SCS) agreements, information regarding prioritized SCS agreements, and information regarding BA agreements, such as shortened maximum (Max) BA window size.

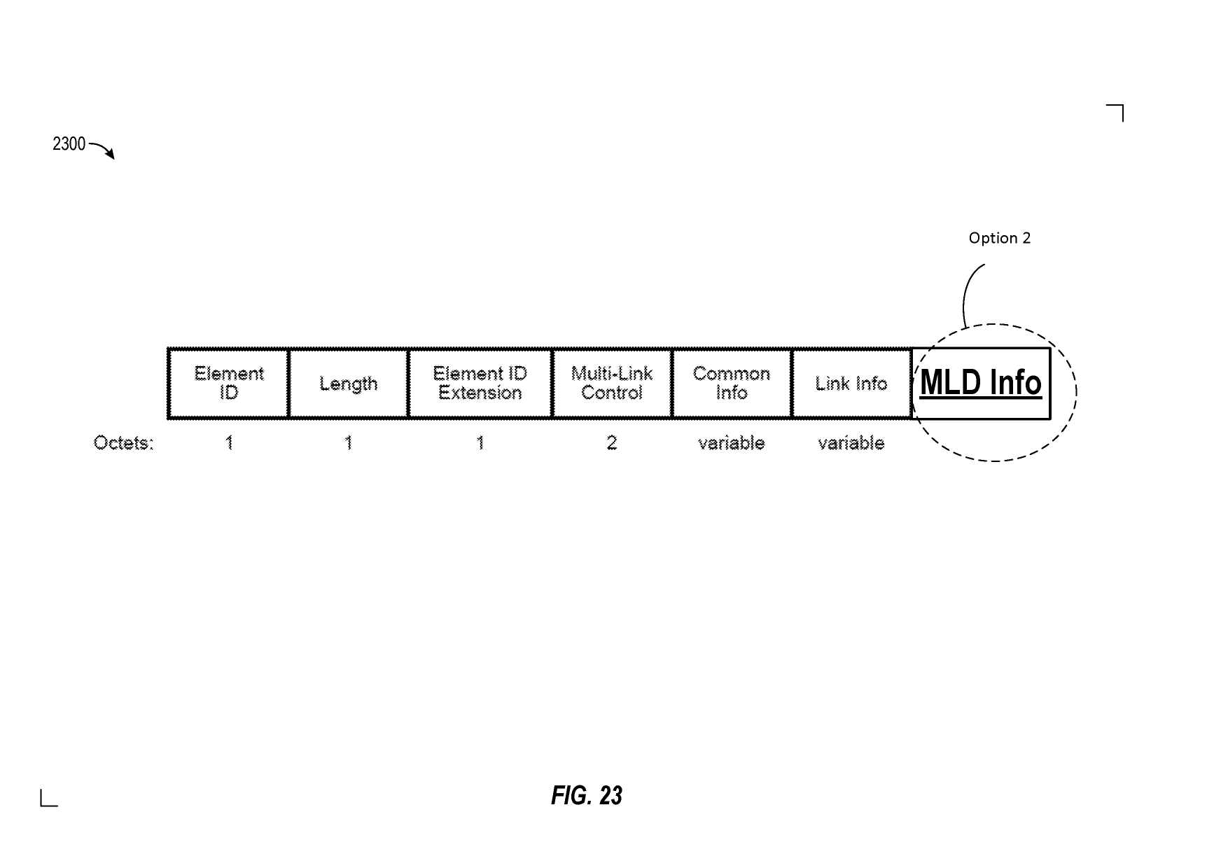

According to another option (Opt3), illustrated in diagram 2300 of FIG. 23, a new field may be introduced (e.g., MLD Info field). This field may be carried, for example, in an ML IE, when carried in the Link Reconfig Request/Response frames.

### Example Methods

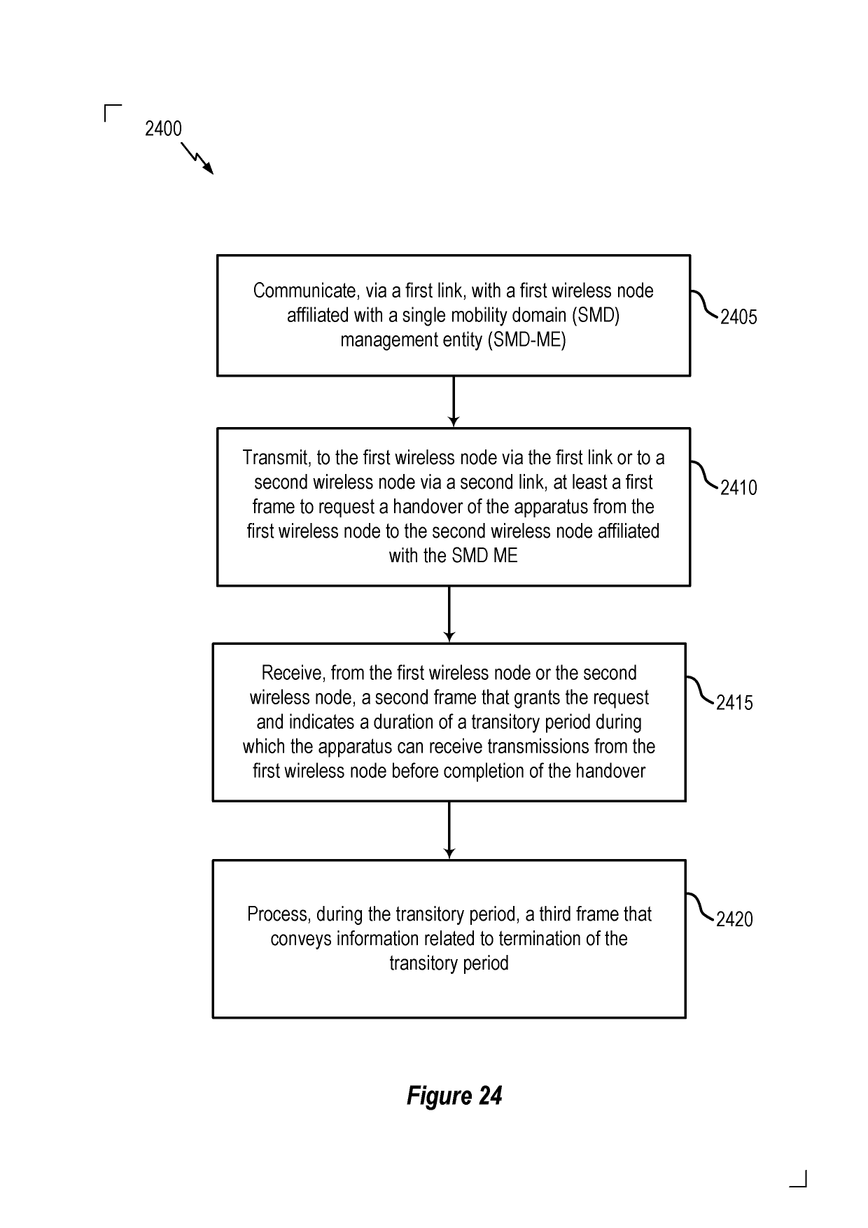

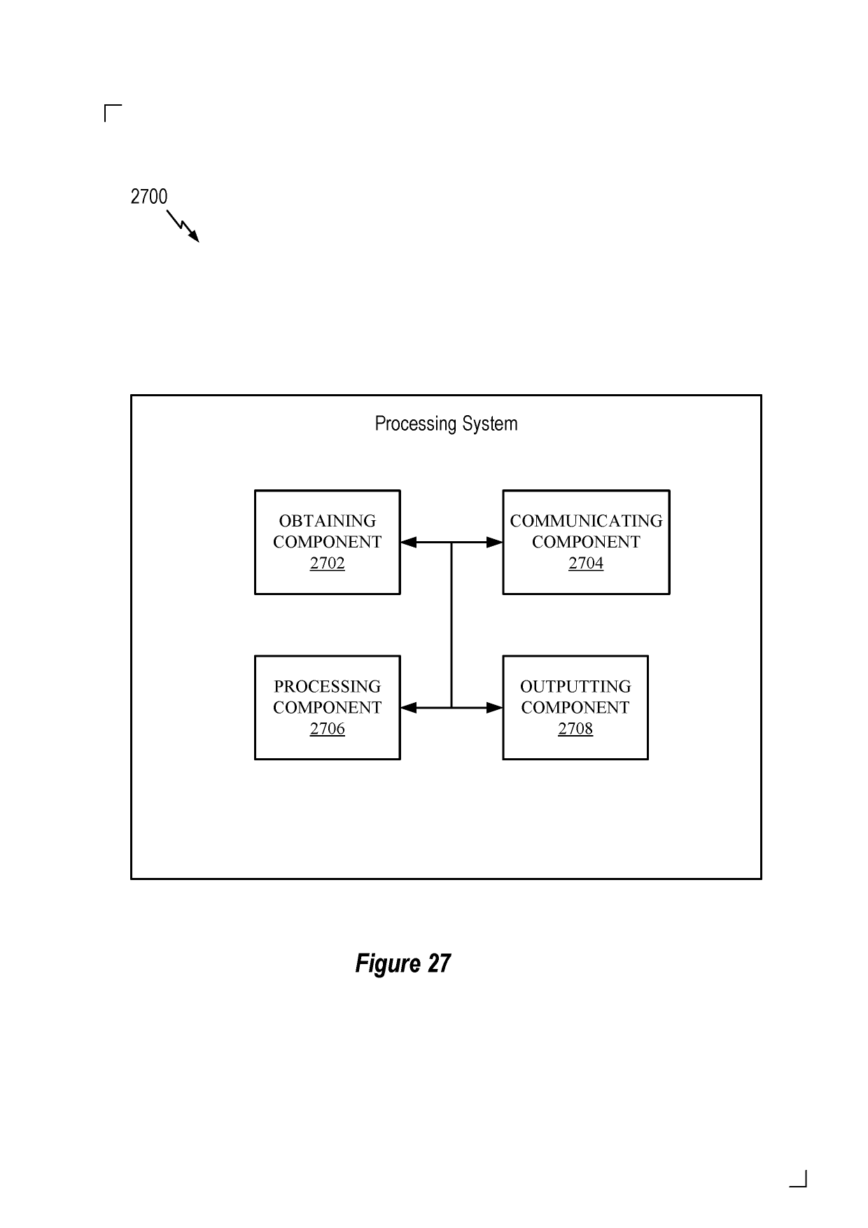

FIG. 24 shows a flowchart illustrating an example process performable by or at a wireless node (e.g., a non-AP MLD STA) that supports early termination. For example, the process 2400 may be performed by a wireless communication device 2700 described with reference to FIG. 27.

In some examples, in block 2405, the non-AP MLD communicates, via a first link, with a first wireless node affiliated with a single mobility domain (SMD) management entity (SMD-ME).

In some examples, in block 2410, the non-AP MLD transmits, to the first wireless node via the first link or to a second wireless node via a second link, at least a first frame to request a handover of the apparatus from the first wireless node to the second wireless node affiliated with the SMD ME.

In some examples, in block 2415, the non-AP MLD receives, from the first wireless node or the second wireless node, a second frame that grants the request and indicates a duration of a transitory period during which the apparatus can receive transmissions from the first wireless node before completion of the handover.

In some examples, in block 2420, the non-AP MLD processes, during the transitory period, a third frame that conveys information related to termination of the transitory period.

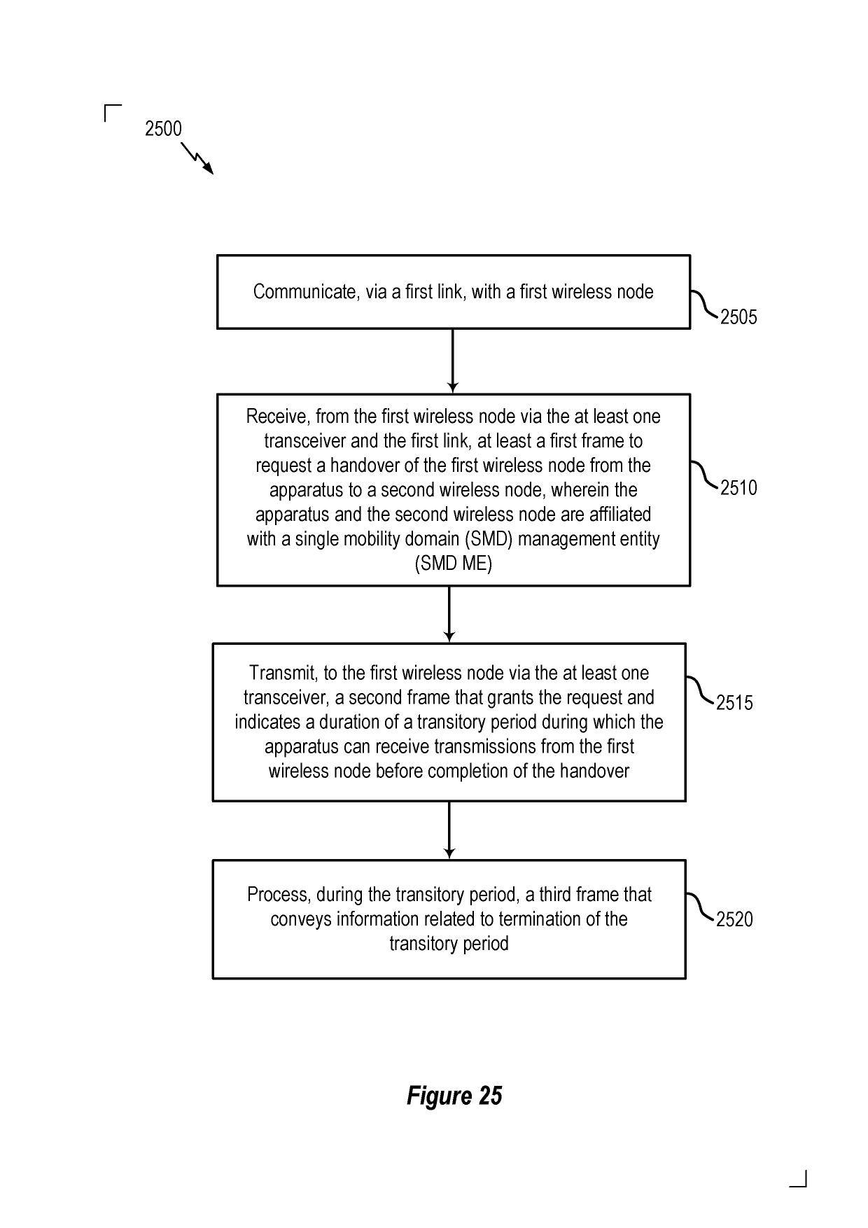

FIG. 25 shows a flowchart illustrating an example process performable by or at a wireless node (e.g., a current AP MLD) that supports early termination. For example, the process 2500 may be performed by a wireless communication device 2700 described with reference to FIG. 27.

In some examples, in block 2505, the current AP MLD communicates, via t a first link, with a first wireless node.

In some examples, in block 2510, the current AP MLD receives, from the first wireless node via the at least one transceiver and the first link, at least a first frame to request a handover of the first wireless node from the apparatus to a second wireless node, wherein the apparatus and the second wireless node are affiliated with a single mobility domain (SMD) management entity (SMD ME).

In some examples, in block 2515, the current AP MLD transmits, to the first wireless node via the at least one transceiver, a second frame that grants the request and indicates a duration of a transitory period during which the apparatus can receive transmissions from the first wireless node before completion of the handover.

In some examples, in block 2520, the current AP MLD processes, during the transitory period, a third frame that conveys information related to termination of the transitory period.

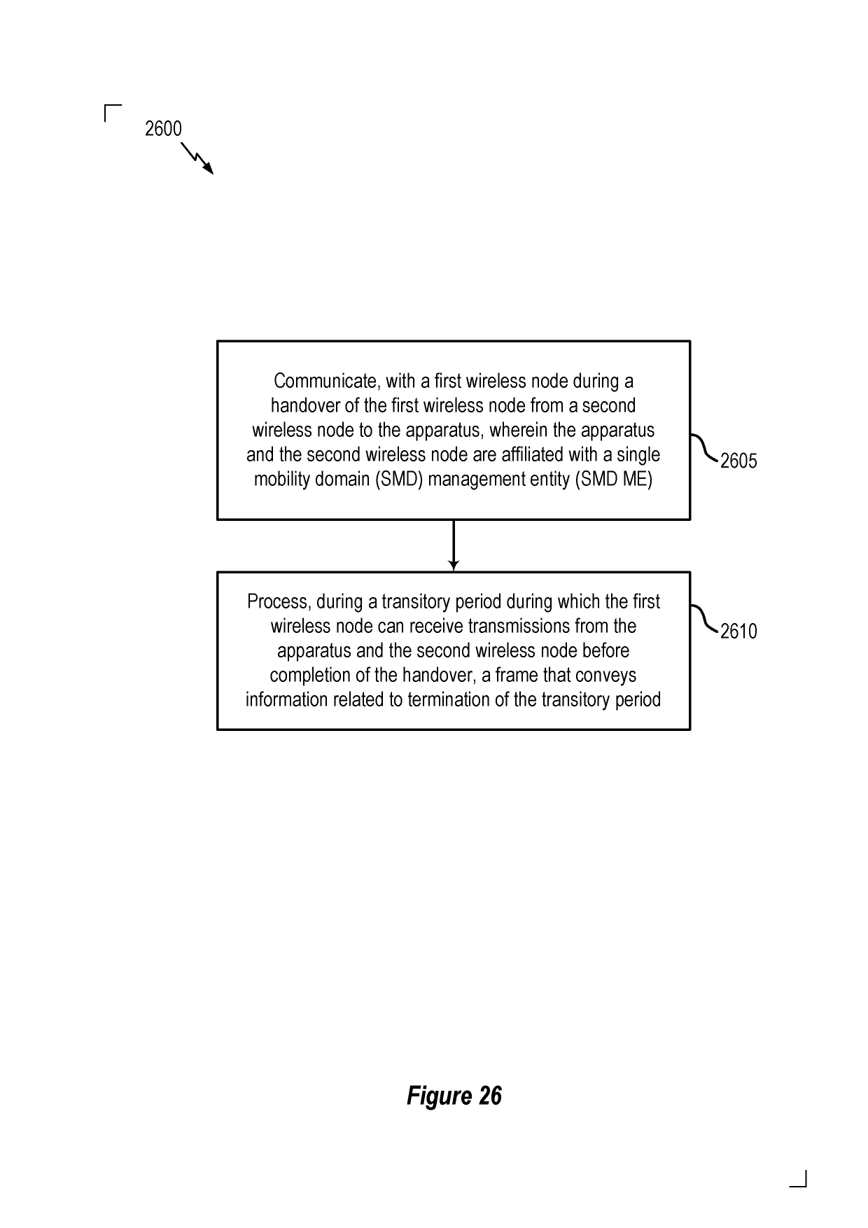

FIG. 26 shows a flowchart illustrating an example process performable by or at a wireless node (e.g., a target AP MLD) that supports early termination. For example, the process 2600 may be performed by a wireless communication device 2700 described with reference to FIG. 27.

In some examples, in block 2605, the target AP MLD communicates, via the at least one transceiver, with a first wireless node during a handover of the first wireless node from a second wireless node to the apparatus, wherein the apparatus and the second wireless node are affiliated with a single mobility domain (SMD) management entity (SMD ME).

In some examples, in block 2610, the target AP MLD processes, during a transitory period during which the first wireless node can receive transmissions from the apparatus and the second wireless node before completion of the handover, a frame that conveys information related to termination of the transitory period.

### Example Communications Device

FIG. 27 depicts a block diagram of an example wireless communications device capable of performing operations described herein.

FIG. 27 shows a block diagram of a wireless communication device or wireless node 2700 (e.g., an AP, a non-AP STA, an AP MLD, a non-AP MLD), according to some aspects of the present disclosure. For example, the wireless communication device 2700 may be configured or operable to perform one or more of the process 2400 described with reference to FIG. 24, the process 2500 described with reference to FIG. 25, or the process 2600 described with reference to FIG. 26.

The wireless communication device 2700 may include one or more chips, SoCs, chipsets, packages, components or devices that individually or collectively constitute or comprise a processing system. The processing system may interface with other components of the wireless communication device 2700, and may generally process information (such as inputs or signals) received from such other components and output information (such as outputs or signals) to such other components. In some aspects, an example chip may include a processing system, a first interface to output or transmit information and a second interface to receive or obtain information. For example, the first interface may refer to an interface between the processing system of the chip and a transmission component, such that the device 2700 may transmit the information output from the chip. In such an example, the second interface may refer to an interface between the processing system of the chip and a reception component, such that the device 2700 may receive information that is then passed to the processing system. In some such examples, the first interface also may obtain information, such as from the transmission component, and the second interface also may output information, such as to the reception component.

The processing system of the wireless communication device 2700 includes processor (or “processing”) circuitry in the form of one or multiple processors, microprocessors, processing units (such as central processing units (CPUs), graphics processing units (GPUs) or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled with one or more of the processors and may individually or collectively store processor-executable code that, when executed by one or more of the processors, may configure one or more of the processors to perform various functions or operations described herein. Additionally or alternatively, in some examples, one or more of the processors may be preconfigured to perform various functions or operations described herein without requiring configuration by software. The processing system may further include or be coupled with one or more modems (such as a Wi-Fi (for example, IEEE compliant) modem or a cellular (for example, 3GPP 4G LTE, 5G or 6G compliant) modem). In some implementations, one or more processors of the processing system include or implement one or more of the modems. The processing system may further include or be coupled with multiple radios (collectively “the radio”), multiple RF chains or multiple transceivers, each of which may in turn be coupled with one or more of multiple antennas. In some implementations, one or more processors of the processing system include or implement one or more of the radios, RF chains or transceivers.

In some examples, the wireless communication device 2700 can be a device for use in an AP or an AP MLD, such as AP 102 described with reference to FIG. 1. In some other examples, the wireless communication device 2700 can be an AP that includes such a processing system and other components including multiple antennas. The wireless communication device 2700 is capable of transmitting and receiving wireless communications in the form of, for example, wireless packets. For example, the wireless communication device 2700 can be configurable or configured to transmit and receive packets in the form of physical layer PPDUs and MPDUs conforming to one or more of the IEEE 802.11 family of wireless communication protocol standards. In some other examples, the wireless communication device 2700 can be configurable or configured to transmit and receive signals and communications conforming to one or more 3GPP specifications including those for 5G NR or 6G. In some examples, the wireless communication device 2700 also includes or can be coupled with one or more application processors which may be further coupled with one or more other memories. In some examples, the wireless communication device 2700 further includes at least one external network interface coupled with the processing system that enables communication with a core network or backhaul network that enables the wireless communication device 2700 to gain access to external networks including the Internet.

In some examples, the wireless communication device 2700 can be a device for use in a STA or a non-AP STA, such as STA 104 described with reference to FIG. 1. In some examples, the wireless communication device 2700 further includes a user interface (UI) (such as a touchscreen or keypad) and a display, which may be integrated with the UI to form a touchscreen display. In some examples, the wireless communication device 2700 may further include one or more sensors such as, for example, one or more inertial sensors, accelerometers, temperature sensors, pressure sensors, or altitude sensors.

The wireless communication device 2700 includes obtaining component 2702, communicating component 2704, processing component 2706, and outputting component 2708. Portions of one or more of the components 2702-2708 may be implemented at least in part in hardware or firmware.

Various components of the wireless communication device 2700 may provide means for performing operations described herein, or any aspect related thereto. Means for receiving or obtaining may include transceivers and/or antenna(s) of the AP 102 (or the STA 104) described with reference to FIG. 1 and/or the obtaining component 2702 of the wireless communication device 2700. Means for transmitting, sending or outputting (e.g., for transmission) may include transceivers and/or antenna(s) of the AP 102 (or the STA 104) described with reference to FIG. 1 and/or the outputting component 2708 of the wireless communication device 2700.

In some cases, rather than actually transmitting, for example, signals and/or data, the wireless communication device 2700 may have an interface to output or provide signals and/or data for transmission (means for outputting or means for providing). For example, a processor may output signals and/or data, via a bus interface, to a radio frequency (RF) front end of the wireless communication device 2700 for transmission. In various aspects, the RF front end may include various components, including transmit and receive processors, transmit and receive MIMO processors, modulators, demodulators, and the like.

In some cases, rather than actually receiving signals and/or data, the wireless communication device 2700 may have an interface to obtain the signals and/or data received from another device (means for obtaining). For example, a processor may obtain (or receive) the signals and/or data, via a bus interface, from an RF front end of the wireless communication device 2700 for reception. In various aspects, the RF front end may include various components, including transmit and receive processors, transmit and receive MIMO processors, modulators, demodulators, and the like. In various aspects, means for obtaining, means for establishing, means for outputting, and means for participating, means for exchanging, and/or means for using may comprise one or more processors (such as the one or more processors/components illustrated in the figures and/or described above).

### Example Clauses

Implementation examples are described in the following numbered clauses:
Clause 1: A method for wireless communications at an apparatus, comprising communicating, via a first link, with a first wireless node affiliated with a single mobility domain (SMD) management entity (SMD-ME); outputting, to the first wireless node via the first link or to a second wireless node via a second link, at least a first frame to request a handover of the apparatus from the first wireless node to the second wireless node affiliated with the SMD ME; obtaining, from the first wireless node or the second wireless node, a second frame that grants the request and indicates a duration of a transitory period during which the apparatus can obtain transmissions from the first wireless node before completion of the handover; and processing, during the transitory period, a third frame that conveys information related to termination of the transitory period.
Clause 2: The method of Clause 1, wherein: processing the third frame comprises obtaining the third frame from the first wireless node; and the information indicates the first wireless node has no more data for the apparatus.
Clause 3: The method of any one of Clauses 1-2, wherein: processing the third frame comprises obtaining the third frame from the first wireless node; at a beginning of the transitory period, the first wireless node is expected to receive data from the first wireless node, wherein the data is associated with one or more traffic identifiers (TIDs); and the information indicates that the apparatus is no longer expected to receive, from the first wireless node, data associated with at least one of the one or more of the TIDs.
Clause 4: The method of any one of Clauses 1-3, wherein: processing the third frame comprises outputting the third frame to the first wireless node; and the information indicates the first wireless node is released from transmitting data to the apparatus that was pending during the transitory period.
Clause 5: The method of any one of Clauses 1-4, wherein the information is conveyed via a medium access control (MAC) header of the third frame.
Clause 6: The method of any one of Clauses 1-5, wherein the information is conveyed via one or more bits in at least one of: a subfield; a quality of service (QoS) control field; a subfield of a control field; or a buffer status report (BSR) control field.
Clause 7: The method of Clause 6, wherein the information is conveyed via one or more bits in the QoS field that indicate a queue size of zero.
Clause 8: The method of Clause 6, wherein the information is conveyed via a control ID value of the subfield of the control field that indicates a source of the third frame has no more data for the apparatus.
Clause 9: The method of Clause 6, wherein the subfield comprises a command and status (CAS) subfield.
Clause 10: The method of any one of Clauses 1-9, wherein the information is conveyed via one or more bits in a MAC (Medium Access Control) Protocol Data Unit (MPDU) delimiter.
Clause 11: The method of any one of Clauses 1-10, wherein the third frame comprises a block acknowledgment (BA) frame or an initial control frame (ICF).
Clause 12: The method of any one of Clauses 1-11, wherein: the information is conveyed via a field; and what information is conveyed depends on whether the apparatus, the first wireless node, or the second wireless node outputs the third frame.
Clause 13: The method of any one of Clauses 1-12, wherein the information is associated with one or more specific traffic identifiers (TIDs).
Clause 14: The method of any one of Clauses 1-13, wherein: the duration of the transitory period is based on a timer; and processing the third frame comprises outputting the third frame to the second wireless node at expiration of the timer.
Clause 15: The method of any one of Clauses 1-14, wherein the one or more processors are further configured to cause the apparatus to: obtain information regarding a split of a block acknowledgment (BA) window between the first wireless node and the second wireless node; and report the information regarding the split to the second wireless node.
Clause 16: A method for wireless communications at an apparatus, comprising: communicating, via a first link, with a first wireless node affiliated with a single mobility domain (SMD) management entity (SMD-ME); outputting, for transmission to the first wireless node, a first frame to initiate a first phase of handover of the apparatus from the first wireless node to a second wireless node affiliated with the SMD ME; obtaining, from the first wireless node, a second frame indicating a response to the first frame; outputting, for transmission to the first wireless node, a third frame to initiate a second phase of the handover; and obtaining, from the first wireless node, a fourth frame indicating a response to the third frame, wherein: each of the first frame and the second frame includes a first indication that it is associated with the first phase of the handover, and each of the third frame and the fourth frame includes a second indication that it is associated with the second phase of the handover.
Clause 17: The method of Clause 16, wherein: the first phase of the handover comprises a preparation phase; and the second phase of the handover comprises an execution phase.
Clause 18: The method of any one of Clauses 16-17, wherein processing the third frame comprises outputting the third frame to the first wireless node; at a beginning of the transitory period, the apparatus is expected to output data to the first wireless node, wherein the data is associated with one or more traffic identifiers (TIDs); and the information indicates that the apparatus is no longer expected to output, to the first wireless node, data associated with at least one of the one or more of the TIDs.
Clause 19: The method of any one of Clauses 16-18, wherein at least one of the first indication or the second indication is conveyed via a frame subtype.
Clause 20: The method of any one of Clauses 16-19, wherein at least one of the first indication or the second indication is conveyed via a frame action type.
Clause 21: The method of any one of Clauses 16-20, wherein: the first message and the third message comprise link reconfiguration request messages; and the second message and the fourth message comprise link reconfiguration response messages.
Clause 22: A method for wireless communications at an apparatus, comprising: communicating, via a first link, with a first wireless node that is a multi-link device (MLD) affiliated with a single mobility domain (SMD) management entity (SMD ME); outputting, for transmission to the first wireless node, a first frame to initiate a first phase of handover of the apparatus from the first wireless node to a second wireless node that is also an MLD and is also affiliated with the SMD ME; obtaining, from the first wireless node, a second frame indicating a response to the first frame; outputting, for transmission to the first wireless node, a third frame to initiate a second phase of the handover; and obtaining, from the first wireless node, a fourth frame indicating a response to the third frame, wherein: at least one of the first frame, the second frame, third frame, or the fourth frame, conveys per-MLD information associated with the handover.
Clause 23: The method of Clause 22, wherein: the first phase of the handover comprises a preparation phase; and the second phase of the handover comprises an execution phase.
Clause 24: The method of Clause 22, wherein the per-MLD information relates to at least one of: establishment of security key; a duration of a transitory period during which the apparatus can receive transmissions from the first wireless node before the completion of the handover; a medium access control (MAC) address of the second wireless node; a request for the first wireless node to refrain from transferring a next sequence number (SN) to the second wireless node; a next SN that the second wireless node will use; one or more parameters of stream classification service (SCS) agreements; or one or more parameters of block acknowledgment (BA) agreements.
Clause 25: The method of Clause 22, wherein: the first message and the third message comprise link reconfiguration request messages; and the second message and the fourth message comprise link reconfiguration response messages.
Clause 26: The method of Clause 25, wherein the per-MLD information is conveyed via at least one of an element or sub-element of at least one of the link reconfiguration request messages.
Clause 27: A method for wireless communications at an apparatus, comprising: communicating, via a first link, with a first wireless node; obtaining, from the first wireless node via the first link, at least a first frame to request a handover of the first wireless node from the apparatus to a second wireless node, wherein the apparatus and the second wireless node are affiliated with a single mobility domain (SMD) management entity (SMD ME); outputting, to the first wireless node, a second frame that grants the request and indicates a duration of a transitory period during which the apparatus can receive transmissions from the first wireless node before the completion of the handover; and processing, during the transitory period, a third frame that conveys information related to termination of the transitory period.
Clause 28: A method for wireless communications at an apparatus, comprising: communicating, via a first link, with a first wireless node; obtaining, from the first wireless node, a first frame to initiate a first phase of handover of the first wireless node from the apparatus to a second wireless node, wherein the apparatus and the second wireless node are affiliated a single mobility domain (SMD) management entity (SMD ME); outputting, to the first wireless node, a second frame indicating a response to the first frame; obtaining, from the first wireless node, a third frame to initiate a second phase of the handover; and outputting, to the first wireless node, a fourth frame indicating a response to the third frame, wherein: each of the first frame and the second frame includes a first indication that it is associated with the first phase of the handover, and each of the third frame and the fourth frame includes a second indication that it is associated with the second phase of the handover.
Clause 29: A method for wireless communications at an apparatus, comprising: communicating, via a first link, with a first wireless node; obtaining, from the first wireless node, a first frame to initiate a first phase of handover of the first wireless node from the apparatus to a second wireless node, wherein the apparatus and the second wireless node are multi-link devices (MLDs) that are affiliated with a single mobility domain (SMD) management entity (SMD ME); outputting, to the first wireless node, a second frame indicating a response to the first frame; obtaining, from the first wireless node, a third frame to initiate a second phase of the handover; and outputting, to the first wireless node, a fourth frame indicating a response to the third frame, wherein: at least one of the first frame, the second frame, third frame, or the fourth frame, conveys per-MLD information associated with the handover.
Clause 30: A method for wireless communications at an apparatus, comprising: communicating with a first wireless node during a handover of the first wireless node from a second wireless node to the apparatus, wherein the apparatus and the second wireless node are affiliated with a single mobility domain (SMD) management entity (SMD ME); and processing, during a transitory period during which the first wireless node can receive transmissions from the apparatus and the second wireless node before the completion of the handover, a frame that conveys information related to termination of the transitory period.
Clause 31: An apparatus, comprising: at least one memory comprising executable instructions; and at least one processor configured to execute the executable instructions and cause the apparatus to perform a method in accordance with any combination of Clauses 1-30.
Clause 32: An apparatus, comprising means for performing a method in accordance with any combination of Clauses 1-30.
Clause 33: A non-transitory computer-readable medium comprising executable instructions that, when executed by at least one processor of an apparatus, cause the apparatus to perform a method in accordance with any combination of Clauses 1-30.
Clause 34: A computer program product embodied on a computer-readable storage medium comprising code for performing a method in accordance with any combination of Clauses 1-30.
Clause 35: A wireless node (e.g., a STA), including: at least one transceiver, at least one memory including instructions; and at least one processor configured to execute the instructions to cause the apparatus to perform a method in accordance with any combination of Clauses 1-15, wherein the at least one transceiver is configured to transmit at least the first frame.
Clause 36: A wireless node (e.g., an AP), including: at least one transceiver, at least one memory including instructions; and at least one processor configured to execute the instructions to cause the apparatus to perform a method in accordance with any combination of Clauses 16-21, wherein the at least one transceiver is configured to receive at least the first frame.
Clause 37: A wireless node (e.g., an AP), including: at least one transceiver, at least one memory including instructions; and at least one processor configured to execute the instructions to cause the apparatus to perform a method in accordance with any combination of Clause 22-26, wherein the at least one transceiver is configured to communicate with the first wireless node.
Clause 38: A wireless node (e.g., an AP), including: at least one transceiver, at least one memory including instructions; and at least one processor configured to execute the instructions to cause the apparatus to perform a method in accordance with any combination of Clause 27, wherein the at least one transceiver is configured to receive at least the first frame.
Clause 39: A wireless node (e.g., an AP), including: at least one transceiver, at least one memory including instructions; and at least one processor configured to execute the instructions to cause the apparatus to perform a method in accordance with any combination of Clause 28, wherein the at least one transceiver is configured to receive at least the first frame.
Clause 40: A wireless node (e.g., an AP), including: at least one transceiver, at least one memory including instructions; and at least one processor configured to execute the instructions to cause the apparatus to perform a method in accordance with any combination of Clause 29, wherein the at least one transceiver is configured to receive at least the first frame.
Clause 41: A wireless node (e.g., an AP), including: at least one transceiver, at least one memory including instructions; and at least one processor configured to execute the instructions to cause the apparatus to perform a method in accordance with any combination of Clause 30, wherein the at least one transceiver is configured to communicate with the first wireless node.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, “a processor,” “at least one processor” or “one or more processors” generally refers to a single processor configured to perform one or multiple operations or multiple processors configured to collectively perform one or more operations. In the case of multiple processors, performance the one or more operations could be divided amongst different processors, though one processor may perform multiple operations, and multiple processors could collectively perform a single operation. Similarly, “a memory,” “at least one memory” or “one or more memories” generally refers to a single memory configured to store data and/or instructions, multiple memories configured to collectively store data and/or instructions.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

Means for obtaining, means for establishing, means for exchanging, and means for participating may comprise one or more processors, such as one or more of the processors described above with reference to FIG. 24.

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. §112(f) unless the element is expressly recited using the phrase “means for”. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. An apparatus for wireless communications, comprising:
at least one transceiver;
at least one memory comprising instructions; and
one or more processors configured to execute the instructions to cause the apparatus to:
communicate, via the at least one transceiver and a first link, with a first wireless node affiliated with a single mobility domain (SMD) management entity (SMD-ME);
transmit, via the at least one transceiver to the first wireless node via the first link or to a second wireless node via a second link, at least a first frame to request a handover of the apparatus from the first wireless node to the second wireless node affiliated with the SMD ME;
receive, via the at least one transceiver from the first wireless node or the second wireless node, a second frame that grants the request and indicates a duration of a transitory period during which the apparatus can receive transmissions from the first wireless node before completion of the handover; and
process, during the transitory period, a third frame that conveys information related to termination of the transitory period.

2. The apparatus of claim 1, wherein:
processing the third frame comprises receiving, via the at least one transceiver, the third frame from the first wireless node; and
the information indicates the first wireless node has no more data for the apparatus.

3. The apparatus of claim 2, wherein:
processing the third frame comprises receiving, via the at least one transceiver, the third frame from the first wireless node;
at a beginning of the transitory period, the apparatus is expected to receive data from the first wireless node, wherein the data is associated with one or more traffic identifiers (TIDs); and
the information indicates that the apparatus is no longer expected to receive, from the first wireless node, data associated with at least one of the one or more TIDs.

4. The apparatus of claim 1, wherein:
processing the third frame comprises transmitting, via the at least one transceiver, the third frame to the second wireless node; and
the information indicates the second wireless node is released from one or more constraints that the second wireless node was subject to during the transitory period.

5. The apparatus of claim 1, wherein:
the duration of the transitory period is based on a timer; and
processing the third frame comprises transmitting, via the at least one transceiver, the third frame to the second wireless node prior to expiration of the timer or at expiration of the timer.

6. The apparatus of claim 1, wherein:
processing the third frame comprises transmitting, via the at least one transceiver, the third frame to the first wireless node; and
the information indicates the first wireless node is released from transmitting data to the apparatus that was pending during the transitory period.

7. The apparatus of claim 1, wherein the information is conveyed via a medium access control (MAC) header of the third frame.

8. The apparatus of claim 1, wherein the information is conveyed via one or more bits in at least one of:
a subfield;
a quality of service (QoS) control field;
a subfield of a control field; or
a buffer status report (BSR) control field.

9. The apparatus of claim 1, wherein:
the information is conveyed via a field; and
what information is conveyed depends on whether the apparatus, the first wireless node, or the second wireless node outputs the third frame for transmission.

10. The apparatus of claim 1, wherein the information is associated with one or more specific traffic identifiers (TIDs).

11. The apparatus of claim 1, wherein the one or more processors are further configured to cause the apparatus to:
transmit, via the at least one transceiver, information regarding a split of a block acknowledgment (BA) window between the first wireless node and the second wireless node; and
report the information regarding the split to the second wireless node.

12. An apparatus for wireless communications, comprising:
at least one transceiver;
at least one memory comprising instructions; and
one or more processors configured to execute the instructions to cause the apparatus to:
communicate, via the at least one transceiver and a first link, with a first wireless node;
receive, from the first wireless node via the at least one transceiver and the first link, at least a first frame to request a handover of the first wireless node from the apparatus to a second wireless node, wherein the apparatus and the second wireless node are affiliated with a single mobility domain (SMD) management entity (SMD ME);
transmit, to the first wireless node via the at least one transceiver, a second frame that grants the request and indicates a duration of a transitory period during which the apparatus can receive transmissions from the first wireless node before completion of the handover; and
process, during the transitory period, a third frame that conveys information related to termination of the transitory period.

13. The apparatus of claim 12, wherein:
processing the third frame comprises transmitting, via the at least one transceiver, the third frame to the first wireless node; and
the information indicates the apparatus has no more data for the first wireless node.

14. The apparatus of claim 13, wherein the information indicates one or more specific traffic identifiers (TIDs) for which the apparatus has no more data for the first wireless node.

15. The apparatus of claim 14, wherein:
processing the third frame comprises transmitting, via the at least one transceiver, the third frame to the first wireless node;
at a beginning of the transitory period, the apparatus is expected to transmit data to the first wireless node, wherein the data is associated with one or more traffic identifiers (TIDs); and
the information indicates that the apparatus is no longer expected to transmit, to the first wireless node, data associated with at least one of the one or more TIDs.

16. The apparatus of claim 12, wherein the information is associated with one or more specific traffic identifiers (TIDs).

17. An apparatus for wireless communications, comprising:
at least one transceiver;
at least one memory comprising instructions; and
one or more processors configured to execute the instructions to cause the apparatus to:
communicate, via the at least one transceiver, with a first wireless node during a handover of the first wireless node from a second wireless node to the apparatus, wherein the apparatus and the second wireless node are affiliated with a single mobility domain (SMD) management entity (SMD ME); and
process, during a transitory period during which the first wireless node can receive transmissions from the apparatus and the second wireless node before completion of the handover, a frame that conveys information related to termination of the transitory period.

18. The apparatus of claim 17, wherein:
processing the frame comprises receiving, via the at least one transceiver, the frame from the first wireless node; and
the information indicates the apparatus is released from one or more constraints that the apparatus was subject to during the transitory period.

19. The apparatus of claim 17, wherein:
a duration of the transitory period is based on a timer; and
processing the frame comprises receiving the frame from the first wireless node prior to expiration of the timer or at expiration of the timer.

20. The apparatus of claim 17, wherein the information is associated with one or more specific traffic identifiers (TIDs).
